(19) United States
(12) Patent Application Publication
(10) Pub. No.: US 2002/0120554 A1
(43) Pub. Date: Aug. 29, 2002

(54) Auction, imagery and retaining engine systems for services and service providers

(76) Inventor: Lilly Mae Vega, Fort Madison, IA (US)

Correspondence Address: ATTEN: STANLEY P. FISHER, REED, SMITH, HAZEL & THOMAS LLP, 3110 FAIRVIEW PARK DRIVE, SUITE 1400, FALLS CHURCH, VA, 22042, US

(21) Appl. No.: 09/796,305

(22) Filed: Feb. 28, 2001

(51) Int. Cl. G06F 17/60

(52) U.S. Cl. 705/37; 705/26; 705/27; 705/39

(57) ABSTRACT

The present disclosure provides a computer-implemented method/system for facilitating communications between service providers and potential customers for services. The computer-implemented method/system provides a marketplace for interactions, both online and off-line, between service providers and potential customers, including purchasing groups, particularly buyer-driven service-related interactions. The marketplace advantageously allows categorization, key word searching, group purchasing, service packaging, data mining, auctions and other commercial features and functionality. The computer-implemented method/system also supports holographic imagery, e.g., in the form of virtual assistants, that facilitates marketplace-related activities. Based on the computer-implemented method/system, service providers are able to efficiently and cost effectively extend the reach of their marketing and promotional activities to a wide range of additional customers, and customers are able to initiate access service providers ideally suited to meet their needs, i.e., buyer-driven commerce, at desirable prices and according to required timeframes.

### BACKGROUND

1. Technical Field

The present disclosure relates to a method and system for facilitating communications between service providers and potential customers for services, and more particularly to a computer-implemented method/system that provides a marketplace, both online and offline, for interactions between service providers and customers for services, particularly buyer-driven service-related interactions. The marketplace advantageously allows categorization, key word searching, group purchasing, service packaging, data mining, auctions and other commercial features and functionality, both online and off-line. The computer-implemented method/system also supports holographic imagery, e.g., in the form of virtual assistants, that facilitate marketplace-related activities.

2. Background Art

Auctions have long-provided a popular and exciting marketplace for the sale of a wide range of products and services. Energetic auctioneers and the potential for value purchases and/or bargain opportunities have attracted potential sellers and purchasers to auctions for generations. Purveyors of goods and services have also recognized auctions as a valuable commercial outlet, whether as a sole vehicle to reach potential purchasers or as an adjunct to other marketing conduit(s). Thus, auction participation has historically extended to extremely wealthy individuals and/or large corporations, as well as individuals of limited means, depending on the nature of the goods/services to be auctioned. Although not required, potential bidders at high-end auctions have often been required to demonstrate, in advance, that they have sufficient funds to pay for high priced goods and/or services that might be acquired through the auction process.

More recently, significant commercial activities have migrated to electronic systems designed to facilitate communications between potential buyers and potential sellers. Initially, electronic commerce was primarily achieved through electronic data interchange (“EDI”), wherein companies communicated data and related information across computer networks established for such purpose. Attention was given to establishing appropriate controls and security systems to ensure EDI participants with appropriate levels of confidentiality and the like.

With the advent, and continued expansion and adoption, of the Internet and the World Wide Web, more and more companies are recognizing EDI as an easy mechanism for buying, selling, and trading products and/or services. Indeed, the American National Standards Institute (“ANSI”) has approved a set of EDI standards known as the “X12 standards.” Vertical markets for the listing, purchase and sale of goods and services have been developed to facilitate such electronic commercial activities. Beyond business-to-business electronic commercial exchanges, business-to-consumer commercial sites have been established on the Internet, and particularly on the World Wide Web, to facilitate commercial activities between individuals and businesses.

The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system or retaining engine. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a Hypertext Transfer Protocol (“HTTP”) request). The request is forwarded to the Web server or retaining engine that supports that Web page. When that Web server or retaining engine receives the request, it sends that Web page to the client computer system. When the client computer system receives that Web page, it typically displays the Web page using a browser. A browser is a special-purpose application program that effects the requesting of Web pages and the displaying of Web pages.

Currently, Web pages are typically defined using Hypertext Markup Language (“HTML”). HTML provides a standard set of tags that define how a Web page is to be displayed. When a user indicates to the browser to display a Web page, the browser sends a request to the server computer system or retaining engine to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

The World Wide Web is especially conducive to conducting electronic commerce. Many Web servers have been developed through which vendors can advertise and sell product. The standard products can include items (e.g., music) that are delivered electronically to the purchaser over the Internet and items (e.g., books) that are delivered through conventional distribution channels (e.g., a common carrier). A server computer system may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items. This purchaser-specific order information may include the purchaser's name, the purchaser's credit card number, and a shipping address for the order. The server computer system then typically confirms the order by sending a confirming Web page and/or e-mail to the client computer system and schedules shipment of the items.

Commercial sites on the Internet (in particular on the World Wide Web) are known. Typically, Web sites where merchandise or services can be purchased consist of a static description of the goods or services being offered, the price at which such goods or services are being offered, and some type of order form for a customer to enter personal and payment information. The known commercial Web sites are interactive only to the extent that a customer is able to choose a particular item for purchase and to enter payment and shipment information. The selection of items from the electronic catalogs is generally based on the “shopping cart” model.

While such Web sites have provided a useful, and rapidly growing, conduit for the sale of goods and services, certain limitations have become apparent. For example, current Web sites are not well suited for commercial exchanges in which relevant purchase terms, e.g., price, quantity discount, payment terms, etc., are negotiable. Similarly, current Web sites have not proven effective for commercial activities in which services, or packages of services, are unique in nature, representative of surplus capacity, and/or discontinued services. Indeed, known commercial Web sites are generally interactive only to the extent that a potential customer is able to choose particular item(s) for purchase and to enter payment and shipment information.

Certain Web sites and associated business models attempt to expand the reach of commercial systems based on electronic exchanges over computer networks. More and more Web users are realizing the ease and convenience of buying and selling online by way of person-to-person online trading. As a result, collectors, hobbyists, small dealers, unique item seekers, bargain hunters, and other consumers, are able to buy and sell millions of items at various online shopping sites. The success of an online retail site generally depends upon its ability to provide an enjoyable experience and an easy-to-use environment in which buyers and retailers can conduct business efficiently. Current online shopping sites have certain limitations in the manner in which they present information to users.

For example, Priceline.com has developed a business model in which airline tickets, hotel rooms, gasoline, telephone services, and the like, are made available to consumers for bid. A customer bid is secured by a credit card, and the customer establishes certain purchase terms that would be acceptable to the customer, e.g., purchase price, date of travel, number of travelers, etc. According to the Priceline.com business model, a matching engine receives the purchaser's “bid” and determines whether a purveyor of goods/services has made available for sale goods/services that match the purchaser's terms. In each case, however, a level of uncertainty must be accepted by the prospective purchaser. For example, the prospective purchaser cannot restrict the air carrier, the specific travel time, or other specifics of the purchase process. Moreover, by submitting a bid, the prospective purchaser is required to accept the offer of a purveyor of goods/services that meets the purchaser's terms, regardless of the prospective purchaser's opinion of such purveyor. Thus, the Priceline.com business model can be effective for selling surplus inventories, provided inter alia. the prospective purchasers are indiscriminate as to who will provide their needs and other specifics of the final purchase.

eBay.com is a further Web-based business model that is designed to allow buyers and sellers to consummate transactions electronically. eBay.com provides a forum where sellers can list products that they are interested in selling. The eBay.com Web site provides an organizational structure for the listing of products, and through such categories facilitates the shopping activities of potential purchasers. The eBay.com business model has provided a useful commercial outlet to businesses and individuals interested in moving merchandise, providing a broad reach to potential purchasers, and providing a modicum of pricing opportunities, through an auction purchase model.

In the service sector, one of the most significant challenges confronted on an ongoing basis is managing and/or forecasting the supply/demand for a company's or entity's services. In the ideal circumstance, a service provider is staffed to provide the precise level of services required by the marketplace, is able to immediately meet a growth in demand, and is able to immediately off-load excess capacity when demand slumps. While conventional schedule management and forecasting systems employ sophisticated tools to project future requirements, and to calculate/schedule staffing needs to meet such future requirements, forecasting errors and/or inherent limitations in forecasting tools invariably lead to unanticipated slow times/seasons, i.e., periods when staffing levels exceed marketplace requirements. Generally, a service provider attempts to utilize its schedule management/forecasting system to project anticipated excess workloads/demands for particular timeframes and to factor in unexpected external events, such as a price war or extreme weather conditions, that can affect a service provider's workload. Based on such projections, service providers endeavor to manage their operations to maximum efficiency and profit.

Based on market forecasts and other projection tools, service providers typically reevaluate the services they provide, the pricing for such services, external market conditions and influences, and staffing levels, in an attempt to match staffing levels to market requirements. Ideally, service providers attempt to avoid “slow” periods, while managing for growth. Of note, a service provider is typically unable to simply discount published fees in an effort to move unsold services and/or utilize excess staffing capacity because such activities would compromise its underlying fee structure. Given such pricing constraints, service providers are generally hamstrung during unexpected slow periods.

One approach to offloading excess capacity currently utilized by some service providers involves the sale of services through brokers, distributors and/or consolidators, who traditionally sell such services at a discount to the typical retail price. Obviously, many types of services are too personal and do not lend themselves to sales through such third parties. Moreover, relationships between service providers and brokers, distributors and consolidators do not provide sufficient flexibility and/or dynamic responsiveness to address a service provider's needs when actual demand fails to meet forecasted demand. Even were a service provider able to release its services for sale through a broker, distributor and/or consolidator at the last minute, there is currently no effective way for such third parties to effectively communicate the availability and price of such services to potential customers.

Most systems for marketing, promoting and selling services to potential customers are established and undertaken by service providers. Thus, the service provider establishes pricing for the services and the nature of the services and/or packaging of services. Based on the decisions made by service providers, buyers evaluate and decide whether to purchase a service provider's offering.

By contrast, in buyer-driven systems, the potential buyer dictates the terms of an offer and one or more service providers decide whether to provide services on the proffered terms. A “help wanted” advertisement, for example, is a buyer-driven inquiry since the employer is seeking to locate and buy the services of a qualified employee. The inquiry is advertised to a large number of potential employees, who may elect to respond, at their discretion, by submitting their resumes to the prospective employer.

There are dozens of different buyer/service provider systems in use today. However, the majority of such systems are service provider-driven, in the sense that such systems focus on methods and processes available to the service provider to price, package or configure services in a manner deemed effective by the service provider. Prices for some services, such as automotive services, change more frequently, but the buyer must still wait for the service provider to offer an acceptable price. Some forms of commerce offer far more give and take, with offers and counteroffers being exchanged, e.g., executive compensation. However, the vast majority of purchases utilize service provider-driven, fixed-price, non-negotiable pricing protocols. Traditionally in such systems, the service provider undertakes to attract clients/customers and then to complete/furnish the service(s) to the client/customer. Thus, in a service provider-driven system, the service provider funds relevant marketing, promotion and advertising costs associated with a potential transaction, and assumes the risk that such marketing, promotion and advertising efforts will prove unsuccessful.

Other commerce systems may be exchange-driven. These systems, such as NASDAQ or the New York Stock Exchange (NYSE), match buyers and sellers by offering an efficient, fair and orderly marketplace. Exchange systems are intended to favor neither buyers nor sellers, but simply effectuate communications that allow for a matching process to take place. An example of an automated exchange-driven, commerce system for trading futures is disclosed in U.S. Pat. No. 4,903,201.

Unilateral, buyer-driven systems of commerce are also known. For example, a typical reward system wherein a “buyer” broadcasts/publishes an offer for a reward to anyone who completes a particular task. That type of system is unilateral because the offer can only be accepted by performance of the designated task. Thus, unilateral systems are generally utilized for limited types of transactions, e.g., those which allow for acceptance by performance.

Many large organizations, such as corporations and government entities, are able to effectively utilize buyer-driven systems to retain services at competitive prices. Initially, the purchaser formulates a detailed written specification, typically called a “Conditional Retaining Offer” (CRO) or a “Request for Proposal” (RFP), setting forth the purchaser's required time frame(s) and scope of work. A CRO/RFP is distributed to a host of known service providers who are believed capable of satisfying the CRO/RFP. Potential service providers then review the CRO/RFP to determine whether to invest the necessary time and effort to submit a formal, legally binding retaining offer/proposal to the buyer, e.g., by a deadline established in the CRO/RFP. Once submitted, the retaining offers/proposals are evaluated by the buyer (a further round of CROs/RFPs may be circulated), and ultimately a chosen service provider, corresponding to the selected retaining offer/proposal, is notified that it has “won” the business according to the submitted offer/proposal and at the price quoted.

Large organizations can take advantage of the benefits afforded by the CRO/RFP process because their volume buying represents a worthwhile opportunity for service providers to compete for their business. In addition, large organizations have the resources and procedures in place to permit effective communication and processing of CROs/RFPs to an appropriately sufficient number of service providers. As a result, large organizations can often achieve substantial unit cost savings, especially on commodity services. Individual consumers, however, cannot effectively utilize a CRO/RFP process with current systems because they generally do not have the bulk retaining power and resources of large organizations.

Bilateral buyer-driven systems seek to consummate contracts between buyers and sellers based on mutual promises to perform. Bilateral buyer-driven systems, however, currently represent an extremely small portion of overall commerce due to a variety of factors. First, and perhaps foremost, buyers generally either cannot, or do not, want to invest the time, money or other resources required to locate an indefinite number of potential sellers and communicate the buyer's purchasing needs to each of the potential sellers. This is especially true of the individual consumer who often cannot afford to pay substantial transaction costs. For example, an individual seeking car repair services generally would not want to contact every repair shop and communicate details of his repair needs to each. The benefits to the consumer from doing so (e.g., achieving a lower price) would be vastly outweighed by the amount of time/money expended in the effort.

Also, buyer-driven systems are not prevalent because buyers do not want to be inundated with numerous offers from potential providers, many of whom may be marginal or unqualified (e.g., a thousand accountants or tax preparers contacting one potential buyer). Buyer-driven systems impose inherent costs on service providers as well. If each buyer has a different set of purchasing specifications and communicates his needs using non-uniform language, service providers must pay a substantial cost even to review and understand each individual request.

While there have been attempts to utilize the Internet and/or the World Wide Web to effectuate bilateral buyer-driven transactions between individual consumers and sellers, those attempts have been largely unsuccessful and/or inefficient. For example, buyers can post “wanted” advertising at little or no cost on “bulletin board” type Internet sites, or submit bids for available products in an online auction, e.g., using the Web site “Interactive Auction Online.” Thus, in an online classified system, consumers can essentially post CROs/RFPs to potential sellers. In an online auction, however, buyers are unable to post an offer to multiple service providers. In either case, individual consumers and smaller businesses are foreclosed from achieving the economies available to large organizations through established CRO/RFP procedures.

In addition, since individual buyers and service providers are typically unknown to each other, and therefore lack the reputation of an institutional buyer or service provider, both parties are typically unwilling to perform until the other has done so. While the service provider is typically unwilling to deliver the services or packages of services until the buyer has paid in full, the buyer is likewise unwilling to pay for the service(s) or packages of services until the service(s) have been delivered and inspected. Each party recognizes that its leverage, or source of recourse, is essentially lost once it has performed. Although an escrow agent or other third party can be involved to reduce such post-transaction performance issues, the escrow agent generally does not: (i) guarantee the authenticity of the buyer's offer; or (ii) reduce the cost of negotiating and consummating a transaction among individual buyers and service providers.

Thus, despite efforts to date, there remain substantial shortcomings in a service provider's ability to manage its operations, and in the electronic marketplace, particularly from the perspective of service providers. For example, current electronic market systems fail to provide an effective mechanism to facilitate negotiation between potential purchasers and suppliers of services, e.g., suppliers of legal services, medical services, construction services, accounting services, and the like. Similarly, current electronic market systems fail to provide an effective mechanism for services to be offered, and acquired, in a manner that addresses the geographic issues associated with service businesses.

Thus, there exists a need for a dynamic and interactive computer-implemented system that facilitates retaining/selling services and/or packages of services through a distributed computer network, such as the Internet or the World Wide Web.

There also exists a need for a buyer-driven system that permits a buyer to retain service(s), or packages of services, at a price set by the buyer that may be advantageously below a service provider's typical retail or published price.

Yet another need exists for a system that permits service providers to dispose of excess service capacity, thereby filling slow times and obtaining value for available staffing during slumps in demand through standard sales channels.

A further need exists for a system that permits service providers to sell services through alternative channels when actual demand fails to meet forecasted demand.

An additional need exists for a buyer-driven system that permits a service provider to sell services to clients/customers at a price set by the client/customer, typically below the service provider's standard fees.

Yet another need exists for a system that permits service providers to stimulate sales of available services, without compromising the service provider's standard price structure.

A further need exists for a system that permits service providers to capture and process consumer demand at different selling prices.

Another need exists for a system that permits passive service providers, e.g., service providers who are not engaged in direct advertising, marketing and promotional activities, to access potential customers for their services.

These and other objects of the present disclosure will be apparent to those skilled in the art from the following detailed description, the accompanying drawings and the appended claims.

### SUMMARY OF THE DISCLOSURE

The present disclosure is directed to a method/system that advantageously facilitates functioning of a marketplace for services and/or packages of services, particularly buyer-driven service-related commercial interactions and activities. According to the method/system of the present disclosure, a potential customer is able to identify and retain desired services at a negotiated price and, preferably, based on a desired geographic location. In particularly preferred embodiments, such commercial activities and interactions are buyer-driven, i.e., the potential customer establishes material terms associated with the purchase of services from service providers and initiates interactions related thereto.

The method/system disclosed herein further facilitates service providers in efficiently accessing latent demand for their services, e.g., based on pricing that is below the service provider's retail and/or published price. In preferred embodiments of the present disclosure, a service provider is able to ensure that a potential purchaser of services will consummate a transaction if the service provider negotiates on price (or other material terms), thereby obviating a risk that the potential customer is merely ascertaining the service provider's underlying level of price flexibility, to the potential detriment of the service provider, e.g., through communication to competitors or other customers.

Thus, the method/system of the present disclosure addresses many deficiencies associated with conventional systems for accessing, negotiating and retaining services from service providers, and concomitant difficulties encountered by service providers in marketing, promoting and advertising their capabilities. Although the method/system of the present disclosure permits buyers and service providers to communicate directly in performing desired projects, e.g., by means of a centralized electronic network, the role of escrow agents or other third parties, is generally not eliminated. Such intermediaries often fulfill essential roles in an Internet marketplace, as their objectivity and/or expertise in authenticating services, or packages of services, provides a mechanism for assuring buyers and service providers that they will not be cheated.

As a rule, the greater the number and complexity of the buyer's retaining conditions, the more difficult it is to effectively implement a buyer-driven marketplace, since costs and logistical difficulties generally rise with the number of conditions that must be communicated, and the potential number of service providers who can (or are willing to invest the resources necessary to) understand and fulfill increasingly complex conditions usually declines. Buyer-driven markets according to the method/system of the present disclosure function best when there is a well-defined purchase need, when a “brand” provides quality assurance to the buyer, such as the name and associated good will of a major service provider, and/or when the service (or packages of services) is associated with a fundamental need, such as medical or in-home health care services. However, the present disclosure is not limited to such circumstances, but rather finds broad utility and applicability.

The disclosed method/system advantageously facilitates processing the retainer of services, such as legal, medical, accounting, and tax-related services. In a preferred embodiment, the disclosed method/system manages the relationship between a service provider, such as an accountant, lawyer, medical practitioner, or construction related service provider, and customers/clients whereby services are provided to such customer/client based on an offer/request/project submitted by the customer/client for retaining such services, preferably utilizing electronic contract applications communicated over computer networks, e.g., the Internet or the World Wide Web.

According to a preferred embodiment of the present disclosure, a computer-implemented method/system for creating a services marketplace is provided. The method/system generally involves providing a site accessible to service providers and purchasers of services, e.g., over the Internet or the World Wide Web. A description of services that are available for purchase and/or a description of the project that is available to be performed are entered at or submitted to the site. Generally, service providers and purchasers are required to register in order to gain access to one or more aspects of the site, Thus, a registration procedure requiring submission of predetermined registration information is typically implemented, and such registration information is stored for future reference, as needed.

Once service providers and/or purchasers have submitted available services and available projects to databases associated with the site, a retaining engine associated with the disclosed method/system automatically determine whether submitted project(s) match service capabilities submitted by service providers. Service descriptions typically include information such as: background information concerning the service provider, contact information for the service provider, pricing schedule for the service provider, sample(s) of work performed by the service provider, link(s) to additional information concerning the service provider, service provider availability, categories for service classification, etc. Similarly, project-related descriptions generally include information such as: background information concerning the purchaser, contact information for the purchaser, maximum price for completion of the project, required timeframe for project completion, categories for project classification, geographic requirements, service-related inquiries, etc.

To facilitate advantageous functioning of the marketplace, service availabilities and projects are generally categorized. Categories may be based on criteria such as of geographic location of the service provider/purchaser, nature of available services/project, availability of service provider/required timeframe for project completion, pricing information, etc. Links may be provided that direct interested parties to additional information concerning the services, projects, service providers and/or purchasers stored within the system. Additional information may take the form of video files, audio files, HTML pages, commercials, banners, testimonial statements, samples of completed work, and the like.

Relevant information concerning the marketplace may be displayed on electronic units, e.g., a personal computer, cellular phone, PDA, television, etc. A variety of communication modes may be utilized to communicate with the marketplace/site, e.g., electronic transmissions, electronic mail, facsimile transmissions, telephone, postal submissions, and/or common carrier submissions. Electronic transmissions are typically encrypted, and access to certain aspects of the marketplace submissions are secured from access by unauthorized third parties.

Based on the submitted service provider capabilities and availabilities, the retaining engine advantageously identifies one or more service providers capable of performing the desired project. Alternatively, in the case of projects displayed at eh site, request(s) and/or commitment(s) to perform the displayed project(s) are generally received from interested service providers. Material terms are generally included in the project to facilitate the retaining engine successfully matching the project with appropriate service providers. Similarly, posted projects generally include material terms such that request(s) and/or commitments in response thereto can address/agree to such terms, e.g., price, payment terms, completion timeframe, service quality, geographic constraints and/or a deadline for response. Non-material terms may be automatically supplemented by the marketplace/site to ensure that a contractual relationship may be effectuated through operation of the retaining engine and/or purchaser/service provider communications pursuant to the disclosed method/system Purchaser submissions may be termed “conditional retaining offers,” as described in greater detail below. Moreover, the marketplace/site may perform valuable verifications with regard to participants, e.g., reliability, creditworthiness, etc.

Upon matching of a project with one or more service provider's capability and availability, and/or receipt of request(s)/commitments in response to posted projects, further communications to and from service provider(s)/purchaser(s) may be effectuated, as the case may be. In preferred embodiments, anti-pinging may be achieved by limiting the ability of service providers/purchasers to make multiple requests/submissions, or the like. Communications between service providers and purchasers may entail outright acceptances, counterproposals and/or requests for clarification/statements. Post-acceptance services may be provided to purchasers and service providers, e.g., processing of payments, dispute resolution, escrow services, and the like. For example, a disinterested third party may be retained to assist with dispute resolution.

In a further preferred embodiment, a virtual assistant is available at the site, the virtual assistant being computer-generated and utilizing holographic technology. The virtual assistant may take many forms and preferably responds to voice commands while learning from experiences with its user.

Log files generated at the site/marketplace are typically collected and analyzed, based on what they reflect as to activities at the site. The log files may be utilized to create statistical reports related to such activities, and to perform data mining, personalized communications, e-mail communications, targeted advertising, rewards programs, marketing analysis, market research and the like.

Packages of services may be available for purchase at the site/marketplace, based on service descriptions provided by service providers. The package(s) may be displayed for consideration by potential purchasers and included in determinations by the retaining engine in response to submitted projects. Service providers may allocate service responsibilities and revenues based on their respective participations in the service packages.

A search capability is also provide at preferred sites/marketplaces, the search capability permitting purchasers and service providers to search for services/projects based on stored descriptions. The search capability generally utilizes one or more key words to locate services/projects that are available for purchase/performance. Key words may be selected from among service descriptors, service provider names, service categories, project categories, maximum price levels, deadlines for completion, geographic locations, and the like. In addition, retaining groups may be established reflecting combinations of purchasers utilizing shared financial resources to acquire services at the site/marketplace.

Services/projects in a variety of categories may be handled by the site/marketplace. Preferred services/projects include medical services, legal services, accounting services, financial services, building services, construction services, architectural services, health fitness services, agricultural services, farm services, nursing services, bookkeeping services, administrative services, graphic design services, photographic services, programming services, Web design and development services, and the like. Auctioning of services/projects is also contemplated, and a mechanism is provided whereby participants need not be actively involved for their bids to be presented at appropriate juncture(s) In circumstances where multiple bids are received to perform a posted project and/or multiple service providers capable of performing a submitted project are identified by the retaining engine, a hierarchical listing of the multiple possibilities is established based on predetermined criteria, e.g., response time, prior commitments received from the service providers, and prior performances by the service providers, and communicated to the prospective purchaser. The purchaser is then free to select from among the responding/matching service providers, e.g., based on supplemental information concerning such service providers. The site/marketplace also advantageously provides computer-based interactivity between service providers and purchasers, e.g., chat and/or instant messaging.

Additional features, functions and advantages of the disclosed method/system will be apparent from the detailed description that follows.

### BRIEF DESCRIPTION OF THE FIGURE(S)

To assist those of skill in the art to which the present disclosure appertains, reference is made to the accompanying drawings and detailed description which follows, in which:

FIG. 1 is an exemplary schematic chart depicting aspects of an embodiment of the method/system of the present disclosure;

FIG. 2 is a block diagram illustrating aspects of a buyer-driven method/system according to the present disclosure; and

FIG. 3 is a block diagram illustrating aspects of a further embodiment of the present disclosure.

### DETAILED DESCRIPTION OF PREFERRED EMBODIMENT(S)

According to the disclosed method/system, the Internet/World Wide Web becomes especially conducive to conducting electronic retaining commerce, i.e., retaining services from service providers pursuant to terms and conditions that are preferably established by potential purchasers, i.e., buyer-driven, and negotiated/consummated electronically via the Internet/World Wide Web. The disclosed retaining engine methodology allows service providers to easily and effectively market, advertise, promote and sell their services according to the disclosed retaining method, particularly the disclosed buyer-driven retaining method. In preferred embodiments of the present disclosure, services may be advantageously retained based upon and/or broken down into geographical locations, parameters and/or criteria.

The method/system finds broad applicability to services, packages of services, and service providers (e.g., medical, financial, architectural and/or legal services) that may be negotiated with entities have geographically extended capabilities, the specific services in a specific geographic locale typically being delivered through conventional local distribution channels (e.g., a local service provider). Examples of services and service providers that may benefit from the disclosed method/system include medical services, legal services, accounting services, financial services, building services, construction services, architectural services, health fitness services, agricultural services, farm services, nursing services, bookkeeping services, administrative services, graphic design services, photographic services, programming services, Web design and development services, and combinations thereof.

In a preferred embodiment of the disclosed method/system, a retaining engine computer system provides an electronic version of a catalog that advantageously lists the services, or packages of services, that are available. Available services/packages of services are typically broken into categories, e.g., medical, legal, financial, etc. A user, who is a potential client or purchaser, may access the retaining engine computer system through conventional Internet technology, e.g., using a browser on his/her personal computer, PDA, cellular phone, or the like, to browse through the catalog of services. On-demand audio and/or video files may supplement conventional HTML Web pages within the catalog to effectively communicate and/or illustrate the available services. The user/potential customer may select various services, or packages of services, from among the services listed in the catalog that are to be retained, i.e., services to be purchased by the user.

When the user has completed selecting the services or packages of services to be retained, the retaining engine computer system according to the present disclosure prompts the user for information to complete the retainer, i.e., ordering of the services or package of services. This purchaser/client-specific retaining order information may include the purchaser/client name, the purchaser/client credit card number, e-mail address, and a shipping address or geographical location of where the service(s) are to be performed and or delivered for the retainer or order. The retaining engine computer system typically confirms the retainer or order, e.g., by sending a confirming Web page and/or e-mail communication to the client computer system. The retaining engine also schedules the services or packages of services, as discussed in greater detail hereinbelow.

Of note, the method/system of the present disclosure provides significant geographic scope and flexibility. Thus, service providers that are limited to specific geographic locations with respect to the services they are able to perform can effectively restrict their retentions to services to be rendered within the restricted geographic location. Similarly, purchasers that require service providers to perform the desired services in a specific geographic location can effectively restrict the service providers under consideration, and those that are able to bid for the business opportunity, to those service providers able to perform within the specific geographic location. Conversely, services that are agnostic as to geographic location of both service provider and purchaser need not entail geographic restrictions in the retention process. Similarly, service providers that are possess an ability to provide services on a geographically dispersed basis, e.g., through a broker/dealer and/or franchise system, are able to pursue retentions regardless of geographic requirements. As such, service deliveries may be achieved on behalf of service providers through affiliated entities, agents, brokers, distributors, franchises or other cooperative relationships, thereby satisfying geographic requirements of prospective purchasers.

Since the purchaser-specific retaining order information contains sensitive, confidential information (e.g., a credit card number), service providers and purchasers have a shared desire to ensure the security of such information. Security is a concern because information transmitted over the Internet/World Wide Web may pass through various intermediate computer systems on its way to its final destination. An unscrupulous person at an intermediate system could intercept the sensitive, confidential information. To help ensure the security of the sensitive information, various encryption techniques are generally used when transmitting such information between a client computer system and a retaining engine computer system, as are known in the art. Even though such encrypted information may nonetheless be intercepted, because the information is encrypted, it is generally useless to the interceptor. Nevertheless, there is always a possibility that the interceptor may successfully decrypt such sensitive information and, therefore, it is desirable to minimize the sensitive information transmitted when placing a retaining request or order.

The selection of the various services or packages of services from the electronic catalog(s) according to the disclosed method/system activates a “scheduling retaining cart” associated with the retaining engine. In particular, when a purchaser selects a service or package of services from an electronic catalog, the retaining engine computer system adds that item, i.e., service, to a “scheduling retaining cart.” When the purchaser is done selecting services or packages of services, then all the services or packages of services in the scheduling retaining cart are “retained” (i.e., ordered), immediately upon the purchaser providing required information to consummate the transaction(s), e.g., credit card/billing information, geographic location for service performance, and the like. In a preferred embodiment of the retaining engine according to the present disclosure, when a purchaser selects a service, then that service is “retained” by the retaining engine automatically prompting the user for all required information, e.g., credit card/billing information, etc.

Retained orders constitute “conditional retaining orders” (CROs) according to the disclosed method/system Once finalized through submission of requisite information, CROs are distributed by the system/method of the present disclosure to a plurality of pre-identified, potential service providers. If the value of the CRO is high enough, as it might be with a large government contract or the like, the user may elect to bear the added expense of trying to attract the widest number of service providers, e.g., by paying to publish the CRO in newspapers and trade magazines. Such ancillary services, i.e., publishing CROs for wider distribution, are contemplated according to the present disclosure.

A potential service provider that is among the plurality of service providers that receives a CRO according to the disclosed method/system, typically determines whether the CRO is directed to service(s) that they might be able to fulfill. Such determination generally entails a consideration of whether to invest the necessary time and effort to submit a formal proposal in response to the CRO. Typically, a percentage of the plurality of service providers that receive the CRO respond thereto by submitting a binding proposal to the user/buyer, e.g., by a deadline generally established in the CRO.

Upon receipt of proposals from among the plurality of service providers, the buyer/user evaluates those proposals with an eye toward selecting an acceptable proposal. One proposal may be selected from among the submitted proposals and, in such case, the corresponding service provider is notified that it has “won” the business at the price (and according to the ancillary terms) quoted. Alternatively, the buyer/user may require additional information/clarification from one or more of the submitting service providers, in which case further communications may take place, whether electronic, written or verbal, to ascertain the required information and permit the purchaser/user to select an appropriate service provider.

A centralized buyer-driven system of bilateral electronic commerce capable of being utilized by even small consumers to communicate their retaining needs globally to potential service providers is thus provided according to the present disclosure. The advantages of the disclosed method/system are manifold. The method/system provides potential buyers an efficient, cost effective mechanism to reach a large market of potential service providers. It also allows the buyer to set the terms he/she is willing to accept. As an additional advantage, it gives service providers an indication of the state of the market for their service(s) or packages of services based on the nature, volume and quality of CROs received through the disclosed method/system. In addition, through the use of electronic communications over the Internet/World Wide Web, communication costs and associated infrastructure is kept to a minimum.

To facilitate widespread adoption and success of the disclosed method/system, a key element involves achieving and maintaining a critical mass of service provider participation in the disclosed bilateral electronic buyer-driven system. From the service provider's perspective, the disclosed method/system is highly desirable because of the service provider's inherent ability to bind a buyer to a legal contract under the terms of the buyer's posted offer, as disclosed herein. In contrast to a non-binding “request for proposal” or other similar quoting mechanisms, a binding offer/retainer from a buyer is highly attractive to a potential service provider. Indeed, a binding offer/retainer that sets forth each material term/condition under which the buyer will allow himself to be bound provides significant motivation to a potential service provider in responding to a CRO. Potential service providers do not need to worry about the costs of negotiating terms of the retainer/sale with the individual buyer because the buyer has laid out the material terms in his/her offer. Additionally, allowing a service provider to bind the buyer on the front end of a potential transaction necessarily alleviates many of a service provider's concerns regarding enforcement and delivery.

In preferred embodiments of the present disclosure, it may be desirable to involve a third party to administer portions of the disclosed bilateral buyer-driven system. A third party may advantageously serve as a trusted arbitrator, available to resolve contract disputes between the parties, thereby increasing buyer and service provider confidence in the disclosed buyer-driven system. Additionally, a third party may establish standard protocols, formats, terms and language to be used in formulating buyer offers/CROs, thereby making it easier for service providers to understand and assess individual offers. It is further contemplated according to the present disclosure that a Web site on the Internet may be created and maintained, such Web site providing a location where buyers can easily post retaining offers/CROs, and service providers can visit to review posted offers. Having offers in a centralized location, e.g., a centrally hosted Web site, would increase the ease and reliability of the method/system of the present disclosure.

Thus, the disclosed method/system facilitates unique bilateral buyer-driven electronic commerce that offers the capability for individual buyers to issue authenticatable messages that contain the terms of a retaining offer/CRO, and to broadly publish the retaining offer/CRO, e.g., globally, to potential service providers. The disclosed method/system further allows a service provider that meets the terms of the retaining offer/CRO to bind the buyer to accept the service provider's fulfillment of that offer. The service provider is typically able to collect appropriate funds, e.g., a deposit, available for retaining purposes immediately upon acceptance of the buyer's terms, as set forth in the retaining offer/CRO. In such circumstance, a service provider may ideally receive partial payment upon agreeing to the buyer's retaining offer, and a subsequent payment upon delivery of the service(s) and or packages of services called for in the buyer's retaining offer, In addition, a trusted third-party administrator is preferably available to intercede according to the method/system of the present disclosure, such third party's decision regarding the fulfillment, adequacy or interpretation of any aspect of the process being binding on the parties in preferred embodiments of the present disclosure.

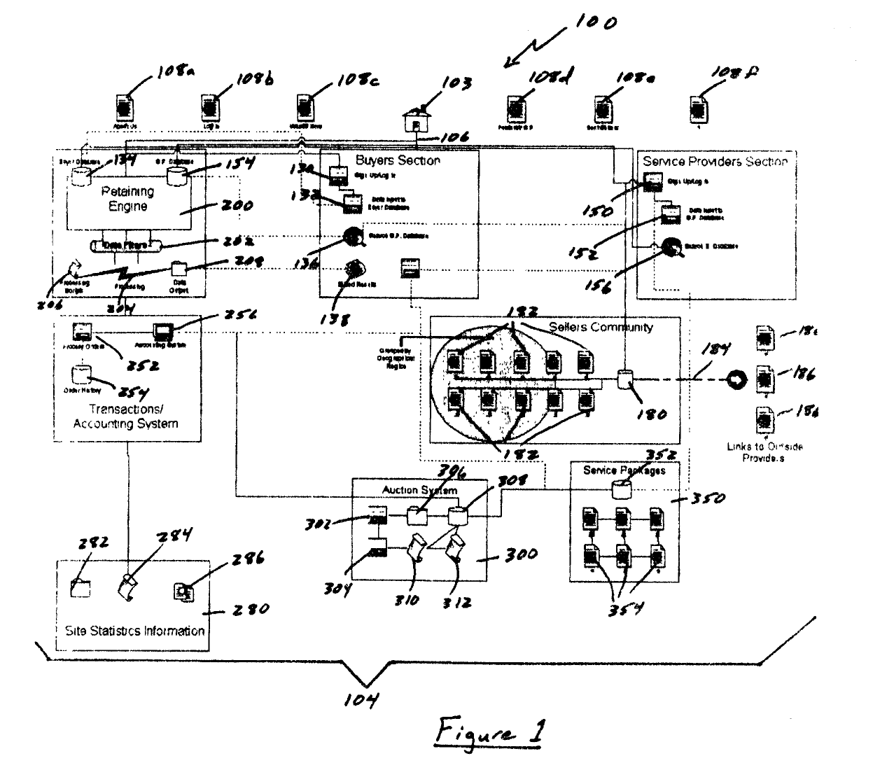

To further assist in describing exemplary embodiment(s) of the disclosed method/system, reference is made to the attached figure. With reference to FIG. 1, an exemplary schematic chart is provided showing various aspects of a system 100 according to the present disclosure. An exemplary user 102 is depicted interacting with retaining engine system 104 at home page 103 across network communications 106. User 102 is representative of a plurality of users that would interact with retaining engine system 104, according to the method/system of the present disclosure. As shown in FIG. 1, user 102 initially communicates with home page 103 of retaining engine system 102. The disclosed method/system is not limited to interaction with users employing personal computers. Rather, system 100 is designed for communication with users at a wide range of locations, e.g., home, office, school, temporary residences, etc., and using a wide range of communication tools, e.g., personal computers, PDAs, cellular phones, etc.

As depicted in FIG. 1, home page 103 includes a series of Web page links 108 associated with one or more Web pages accessible by a user 102. Thus, user 102 may access Web page(s) associated with retaining engine system 102 through conventional means, e.g., entering an appropriate URL in a Web browser, performing a browser search of relevant Web sites, and/or linking from another Web site and/or Web portal. According to preferred embodiments of the disclosed method/system, user traffic to Web page(s) associated with retaining engine system 102 is driven by marketing, promotion and viral activities, e.g., word-of-mouth.

Web page links 108 included in FIG. 1 are “About Us” link 108a, “Log In” link 108b, “What's New” link 108c, “Featured Service Providers” link 108d, “Best Sellers” link 108e, and “Undefined” link 108f As will be readily apparent to persons skilled in the design and/or operation of Web sites, Web page links 108 are merely exemplary of the types of links that might be placed on a home page or elsewhere within a Web site. HTML programming of Web sites is well known, and the design, development and deployment of appropriate Web page(s) according to the present disclosure is well within such skill level.

“About Us” link 108a guides a user 102 to a Web page providing typical information concerning a Web site owner, e.g., nature of business, management personnel, mailing/e-mail address, etc. “Log In” link 108b guides a user 102 and/or service provider (not pictured) to sign up/log in wizards 130, 150, respectively. Generally, sign up wizards 130, 150 collect relevant information concerning a user and a service provider, respectively, through data input screens 132, 152. For example, sign up wizards 130, 150 and data input screens 132, 152 may advantageously solicit user name, company name, mailing address, e-mail address, log in name and password, and/or credit card information (particularly in the case of sign up wizard 130/input screen 132 for prospective buyers). Additional information may also be solicited to facilitate data mining purposes, e.g., demographic information such as salary bracket, profession, age, family size and status, etc. Similarly, additional information may be solicited from service providers (and users that are not visiting in their individual capacities), e.g., nature of business, annual revenues, number of employees, service categories, etc. Thus, sign up wizards 130, 150 and data input screens 132, 152 collect information/data that is stored in buyer database 134 and service provider database 154, respectively.

Returning to the Web page links 108, “What's New” link 108c typically guides a user 102 or service provider to information concerning retaining engine system 104 and the associated business operations of the owner thereof. Thus, the “What's New” link may guide visitors to a Web page that describes new functionalities and/or capabilities of retaining engine system 104, adoption figures for system 100, and the like. The design and utility of “What's New” pages on the World Wide Web are well known to persons familiar with the Internet and Internet-based activities.

“Featured Service Provider” link 108d guides potential visitors to a Web page that provides information, e.g., capabilities and/or case studies, for service providers that are being featured by retaining engine system 104, e.g., based on new services, new geographic expansions, successful utilization of retaining engine system 104, and the like. Thus, a user 102 visiting retaining engine system 104 can readily identify and learn about individual service providers of potential interest based on criteria to be established by the operators of “Featured Service Provider” link 108d. It is further contemplated that press releases and industry stories concerning service providers and/or users of retaining engine 104 may be linked at the Web page associated with “Featured Service Provider” link 108d. “Best Sellers” link 108e generally offers a Web page featuring service providers and/or users that are benefiting from retaining engine system 104 and/or service categories, geographic regions or the like, that are experiencing significant transactional revenues through utilization of retaining engine system 104. Thus, “Best Sellers” link 108e generally provides a form of advertising and/or validation for the effectiveness of retaining engine system 104 in matching service providers with users of services.

“Undefined” link 108f may be used for a multiplicity of purposes associated with retaining engine system 104 and is depicted in FIG. 1 for the purpose of conveying the variety of links that may be employed to advantage as part of retaining engine system 104. Thus, undefined link 108f may provide a link to a category listing, a geographic listing, a service provider listing, and/or other Web pages associated with categorization of services available through retaining engine 104. Undefined link 108f may also direct visitors to Web pages providing privacy policy information, contractual terms and conditions, third party administrative services, e.g., escrow agents and dispute resolution services, and status pages associated with pending retaining offers/CROs. In addition, undefined link 108f may direct visitors to various interactive features associated with retaining engine system 104, e.g., chat functionalities between service providers and potential customers and/or between customers and other customers (or service providers and other service providers, e.g., to establish integrated service offerings), data mining functionalities (e.g., reporting or statistical tools), and/or promotional, marketing and informational materials related to service providers and/or general categories of services. Additional links are contemplated to further advance the goals and objectives of the disclosed method/system, as will be readily apparent from the detailed description provided herein.

A first time visitor to retaining engine system 104 may elect to view aspects of the Web site that do not require registration, e.g., “Best Sellers,” privacy policies, terms and conditions, and the like. However, a visitor that wishes to utilize the unique features and functionalities of retaining engine system 104 is generally required to register, whether as a user or a service provider. Once registered, a visitor is able to re-enter restricted areas of the site by providing user name and password, or like information, as is known in the art. A returning visitor will be asked to provide retaining engine system 104 with appropriate registration information, e.g., user name/password, which is then checked against the corresponding information stored in buyer database 134 or service provider database 154, as the case may be.

Beyond registration and demographic information that is input to buyer and service provider databases 134, 154, respectively, additional information is entered into buyer and service provider databases 134, 154 via data input screens 132, 152 according to retaining engine system 104. Focusing first on information entered to service provider database 154 through data input screen 152, services that are available for purchase by prospective buyers is entered to service provider database 154 from time to time. Such services may include a wide range of services, spanning many different and diverse categories. For example, service providers may enter services into service provider database 154 that fall into service fields ranging from legal, medical, nursing, accounting, financial, architectural, counseling, educational, dental and health fitness services, to more hands-on services such as car repair, gardening, painting, plumbing, construction, and any other service that might be of interest to potential buyers.

Registered service providers that are logged in via log in wizard 150 are generally free to populate service provider database 154 with relevant details concerning the services available for purchase, including such information as description of services, geographic location/geographic coverage area, years of experience, references, pricing ranges, times of availability, and the like. Such information is stored in records within service provider database 154, with each record being associated with a specific service provider. In addition, promotional, marketing and advertising information and/or links to reference materials concerning a service provider's capabilities are entered via alternative data input screens 152 and are stored in seller community database 180.

Individual service providers are advantageously categorized within seller community database 180 according to relevant categories. In a preferred embodiment of the retaining engine system 104 of the present disclosure, service providers are categorized according to geographic location/geographic coverage, and/or nature of services provided. Thus, individual listings 182 setting forth service providers and associated information concerning the services of such service providers may be viewed by potential buyers 102 and other validated visitors to retaining engine system 104. Listings 182 may be advantageously accessed as individual Web pages based on category-based links from one or more Web pages associated with retaining engine system 104.

For example, a service provider that specializes in income tax preparation and advice may register with retaining engine system 104 by providing relevant information in response to sign up/log in wizard 150, by entering such information into input screen 152. Such information is stored in service provider database 154. Beyond registering with retaining engine system 104, the tax preparation specialist may also enter information concerning his/her areas of expertise, years of experience, geographic location and geographic scope of practice, standard billing rate, and the like. Such information concerning the tax specialist is also stored in database 154. However, beyond the data stored in database 154, the tax specialist is preferably automatically included in seller community database 180 based on his/her geographic location/geographic scope of practice, e.g., northeastern United States, and future visitors to retaining engine system 104 will find information concerning the tax specialist on listings 182 that concern service providers in the northeastern United States and/or service providers that offer tax preparation services and advice.

Of note, links 184 to ancillary service provider Web pages 186 may be included in the information provided by service providers to seller community database 180. Thus, a visitor to retaining engine system 104 may advantageously link directly from listings 182 to access additional background information concerning service provider(s) of interest. Web pages 186 may provide static information, e.g., HTML pages, video/audio files and/or combinations thereof Through inclusion of links 184, service providers are able to leverage their participation with retaining engine system 104 to provide extensive background information, testimonials, service examples and the like, to prospective buyers.

A registered buyer 102 has the ability to search service provider listings 182 to determine whether services of interest are posted for purchase. In a preferred embodiment of retaining engine system 104, buyer 102 utilizes functionality associated with Web browser 136 to search information contained within service provider database 154 and seller community database 180. Thus, buyer 104 may advantageously select key words/phrases to search within databases 154, 180 in determining the availability of desired services/service providers. Buyer 104 may also advantageously narrow the search scope, e.g., limiting the search to tax preparation specialists located in the northeastern United States, via Web browser 136. Through the networked relationship between Web browser 136 and retaining engine system 104, e.g., across the networked computers that form the Internet and/or the World Wide Web, registered user 104 is able to readily access relevant information contained within databases 154, 180. Similarly, a registered service provider is able to use Web browser 156 to search the information contained within buyer database 134.

Beyond registration-related information, a registered buyer 102 may provide a description of services that the buyer is prepared to purchase by entering relevant information to input screen 132. Such information is advantageously stored within buyer database 134 for processing by retaining engine 200, and for potential review and consideration by registered service providers. According to system 100 of the present disclosure, entry of a service requirement by buyer 102 constitutes a CRO that is binding upon buyer 102 if accepted by a service provider. Thus, buyer 102 is required to input all information necessary to define the scope and pricing of the requested service when entering the record into buyer database 134 via data input screen 132. To the extent nonmaterial information is omitted from the service request created by buyer 102, retaining engine system 104 undertakes to fill such omissions to ensure a binding contractual relationship will be created upon acceptance by a service provider. Retaining engine 200 advantageously matches buyer requests entered to buyer database 134 with corresponding service provider records contained within service provider database 154. Data filter 202 and associated processor 204 screens service requests submitted by buyers 102 to ascertain material terms that must be met by a service provider, e.g., nature of the services requested, timeframe required, maximum cost, geographic location, etc. Based on identification of material terms, data filter 202 and processor 204 apply processing scripts 206 to identify one or more buyer/service provider matches. For example, a buyer 102 who has forwarded a request for tax preparation services in the northeastern United States within the next two weeks at a cost not to exceed $500 may be matched with the tax preparation specialist noted above, provided the tax specialist has availability within the next two weeks and can provide the necessary services in the requested timeframe.

Assuming a match between buyer 102 and the tax specialist, the matched records are transmitted to a transactions/accounting system 250 for further processing. Thus, order processing 252 functions to enter the matched record to an order history database 254. In addition, an accounting system 256 processes payment-related information and processes commissions or the like that may be payable to the operator of retaining engine system 104 in connection with the matching services provided. To the extent a deposit or other payment is due to the service provider, whether at the outset of the retention or over the course of performance, accounting system processes payment, e.g., through the credit card of buyer 102.

Alternatively, processor 204 and processing scripts 206 may be unsuccessful in identifying a single service provider to provide the services requested by buyer 102. For example, multiple service providers may satisfy the requirements outlined by buyer 102 in the record submitted to buyer database 134 (tax preparation services within two weeks in northeastern United States at a cost not to exceed $500). In such circumstance, data output 208 is communicated to buyer 102 concerning the “mined results” 138 generated by retaining engine 200.

Upon receipt of data output 208 setting forth mined results 138, buyer 102 is empowered to perform further evaluation/due diligence and/or initiate direct communications with one or more of the qualifying service providers, to ascertain the most desirable service provider. For example, buyer 102 may request additional credentialing information from one or more qualifying service providers, may review more carefully likely timeframe for completion and/or geographic proximity, and such other factors as buyer 102 deems relevant or helpful. At the conclusion of the buyer's further analysis, buyer 102 advantageously communicates his/her selection to retaining engine 200 so as to benefit from the transaction/accounting system and other aspects of retaining engine system 104.

Completed transactions are advantageously recorded and tracked within site statistics information system 280. Thus, server logs 282 associated with buyer/service provider interactions with retaining engine system 104 may be processed using conventional processing system is 284 to generate valuable reports 286 and other market research information and insights. An operator of retaining engine system 104 may utilize the data collected and reports 286 to provide buyers, service providers, advertisers and other interested third parties with guidance and insights that may benefit such entity's market activities.

With further reference to FIG. 1, an auction system 300 is provided in which seller input data 302 concerning services available for purchase may be displayed in listings 306 for consideration by potential purchasers. Seller input data 302 may also be stored within auction database 308, and may be searched by potential purchasers via purchaser data input 304. Requests are filtered by filter 310 and, based on search script 312, database 308 may be searched based on potential purchaser inquiries. Details with regard to auction system(s) according to the present disclosure are described in greater detail hereinbelow.

Also depicted in exemplary FIG. 1 is a service package module 350 pursuant to which individual services 354 available from one or more service providers may be advantageously combined in service package database 352. Combinations of service packages within module 350 may assist in leveraging complementary services available from one or more service providers, thereby increasing the value and likely interest among potential purchasers.

FIG. 1 is merely exemplary of potential system layouts according to certain aspects of the disclosed methods/systems, and is not intended to be limitative thereof Alternative system layouts may be employed to achieve the benefits, and provide the features and functionalities of the disclosed method/system, as will be readily apparent to persons skilled in the art from the detailed description provided herein.

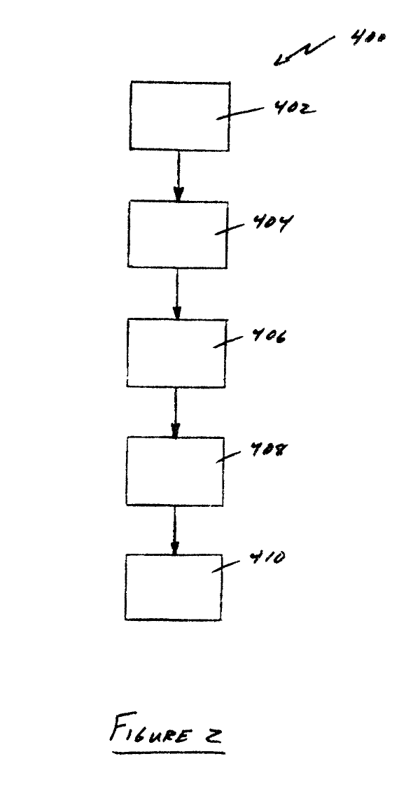

With reference to FIG. 2, an exemplary block diagram corresponding to an illustrative method/system 400 according to the present disclosure is provided. In step 402, a site or marketplace according to the present disclosure is accessible to service providers and purchasers of services, e.g., via the Internet or the World Wide Web. In step 404, descriptions of services that are available for purchase are stored at the site/marketplace, e.g., in a services database. The descriptions are supplied to the site according to step 404 by service providers.

In step 406, a request is received from a purchaser to acquire desired services. A broad range of services may be contained within a purchaser request. Of note, the submission of the request initiates the process toward retaining a service provider, i.e., the process is advantageously buyer-drive. Upon receipt of the purchaser's request, a retaining engine automatically determines whether one or more stored descriptions of services, i.e., submissions already received from service providers, correspond to the purchaser's desired services in step 408. Insofar as the retaining engine determines that matches exist based on the buyer-driven process of method/system 400, such matches are communicated to the purchaser in step 410. The purchaser is thus free to determine whether to retain the identified service provider and/or to select from among identified service providers based upon criteria of importance to the purchaser. Of note, while price may be an important factor, it may not be the determining factor for the purchaser.

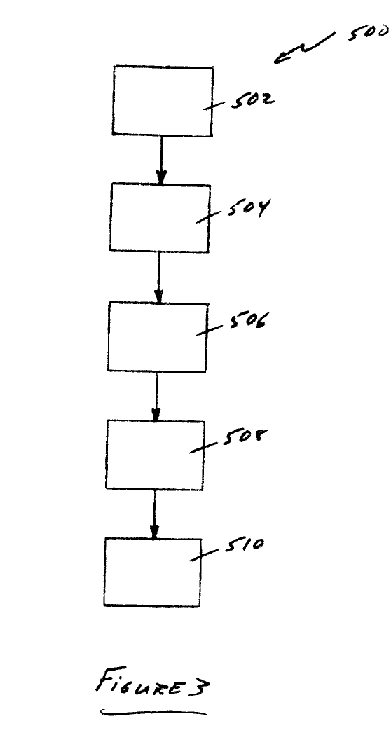

With reference to FIG. 3, an exemplary block diagram similar in appearance to FIG. 4, but corresponding to an alternative illustrative method/system 500 according to the present disclosure, is provided. In step 502, a site accessible to service providers and purchasers of services is provided, e.g., over the Internet or the World Wide Web. In step 504, a description of a project is stored in a database, the project representing an undertaking that a retaining purchaser desires to purchase. The project description is displayed for consideration by a plurality of service providers in step 506. Thereafter, the site/marketplace receives a commitment from at least one of the service providers to perform the project pursuant to the displayed project description, and in step 508, the service provider's commitment is communicated to the retaining purchaser. Thus, according to the disclosed method/system 500, a retaining purchaser is able to broadly disclose the availability of his/her project, and receive commitments from service providers based on the contents of his/her project description. The retaining purchaser may be bound to accept a commitment from a service provider complying with the terms of the project description, or may have the option of moving forward in his/her discretion.

In a further embodiment of the present disclosure, a computer-implemented method and system for negotiating the purchase of goods and/or services by customers is provided in which a downloadable holographic “virtual person/assistant” participates in such negotiation process. The computer-implemented method and system allows consumers to name/state/request their own prices for the services they desire, The computer-implemented method also allows consumers to participate in competitive bidding for all types of services. A broad range of services and service providers are contemplated, and to the extent services include delivery of tangible items/products, such tangible items may be delivered over the Internet, via facsimile, postal service or the like.

The disclosed computer-implemented method/system allows customers to download and create/design their own 3-D holographic image/assistant. The creation/design process allows individual customers to select desired appearance features, gender, race, voice, etc., using known avatar technologies. The 3-D holographic assistant generally responds to consumer interaction, e.g., using voice recognition technology. In a preferred embodiment, the “virtual person/assistant” understands voice commands and learns about the consumer and his/her habits, thereby becoming “smarter” over time. The virtual person/assistant technology disclosed herein can be used in conjunction with retaining engine systems according to the present disclosure using any known communication technology having Internet capabilities, e.g., cellular phones, personal computers, laptops, PDAs, and the like.

The 3-D holograph imagery is typically accessed by consumers as downloadable software, and may be deployed on a small processing device and/or PC video camera capable of displaying the holographic imagery/assistant. According to the present disclosure, it is contemplated that products/services of interest to a consumer are communicated to the “virtual assistant.” In response to such communication, the “virtual assistant” automatically communicates with a company/entity that provides the requested product(s)/service(s) for completion of the request. The “virtual assistant” thus functions as an agent for the consumer, e.g., in the retaining engine system of the present disclosure. Upon completion of the product/service request, a consummated transaction may be established between the company/entity and the consumer.

A further unique aspect of the present disclosure relates to “hologent technology,” i.e., holographic agent technology, that utilizes holographic principles that enable 3-D to 6-D imagery distributed over a computer network. In preferred embodiments of the present disclosure, holographic transmissions over and downloads from a computer network are contemplated, e.g., over the Internet and/or via satellite transmission. Preferred embodiments of the present disclosure utilize such holographic agent technology to facilitate sense recognition over a computerized network, computer downloads that synthesize into holographic imagery, and video transmission technology that advantageously includes and/or constitutes holographic imagery. The holographic agent technology disclosed herein facilitates detection of user emotion in body algorithms, pulse temp, and the like, as well as body language recognition over a computerized network. Further advantageous features and functionalities include holographic voice command recognition, which includes an ability to translate spoken words and/or commands into holographic image(s).

The disclosed holographic agent technology further facilitates social interactive intelligence over a computerized network, holographic downloads, projected holographic imagery over a computer network, i.e., holographic projections, holographic optical networking, holographic fiber optics communications, holo-speed optical routing, interconnect and cross connect holographic communications over a computerized network, and communication of holographic imagery and video over computer networks, including the Internet, whether accessed by personal computers, cellular phones, PDAs, or another access means. It is further contemplated that holographic spatial interaction, holographic rapid image generation over a computerized network, auto stereoscopic secular optical viewing of holographic imagery over a computer network, holographic environments over a computerized network, smart holography and intelligent holography in relation to holographic imagery over a computer network, and holographic optical computing over a computerized network, are available to users/service providers according to the method/system of the present disclosure.

In a preferred embodiment, holographic agent technology is utilized to provide holographic assistant(s) and/or guest speaker(s). Such assistants/speakers are optimally provided with an ability to engage in voice interactions, e.g., to answer questions and/or to change/run on new subjects. Further features/functionality include an ability to engage in computer dispatching based upon voice recognition technology and/or voice recognition appliances that provide e-mail capabilities. Thus, in the context of the unique retaining engine systems disclosed herein, holographic assistant technologies may be utilized to address geographical locations for service providers, e.g., via holographic imagery displayed by or within jewelry (e.g., watches and necklaces) with holographic video technology, over a terrestrial and/or satellite network or other communication system.

For example, a retaining engine system according to the present disclosure may be provided in which downloadable holographic imagery, e.g., a virtual person/assistant, is available to users, e.g., customers and service providers. Based on a user download, the user is able to custom create/design a 3-D to 6-D holographic image and/or an holographic environments. Thus, the user may create a 3-D to 6-D virtual person/assistant having desired appearance, gender, race, voice, etc., as well as an holographic environment, e.g., a virtual environment as to place, ambience, surroundings, conditions, background, and the like. The holographic assistant/imagery created by the user based on the downloaded technology preferably allows the user to interact based on voice recognition. Thus, the user's holographic creations ideally understand voice commands and learn through interactions with the user, e.g., identifying habits, tendencies, preferences, and the like.

The holographic imagery method/system disclosed herein offers wide applicability to a variety of fields, e.g., video transmissions (whether live or on-demand), television transmissions, and/or movie/video/audio files distributed over a computer or satellite network. The holographic imagery technology permits user's to capture and convey subtleties currently lost in computer communications, e.g., sight, sounds, smell, voice, touch, expression recognition, sense recognition, facial expression, and subtle communication techniques (e.g., sly smile, sarcastic eye roll, doubtful raised eyebrow). Further advantages associated with the holographic imagery disclosed herein include an ability to convey and/or detect emotional states via body algorithms (e.g., anger, happiness, boredom, frown, smile, and the like). Thus, the holographic imagery accentuates a user's ability to convey/detect fundamental human traits and emotions.

The method/system of the present disclosure further contemplates an image processing system that preferably functions over a computer or satellite network, the image processing system advantageously producing holographic image(s), e.g., based on an image capture unit that captures a digital image. The image processing system accesses a database of information within which is located selected information that augments the captured digital image to include additional functionality/characteristics, as described herein. Thus, the image processing system preferably includes a video interface for receiving data from the image capture device and transforming such data to a format used by the data processor. The system processes the digital image and the selected scene information to form processed data that represents a holographic image for transmission over a computer or satellite network, or other communication system.

The image processing system may advantageously include a display system and method of operation that generates three-dimensional images based on a plurality of elements arranged in an array, an image projector for selectively projecting images on respective elements to generate a viewable three-dimensional image, and a floating-image generator for projecting the three-dimensional image to generate a second three; dimensional image viewable as floating in space at a location separate therefrom. The images created thereby are preferably transmitted across a computer network, satellite system or other communication system.

A cluster computer system associated with the holographic imaging technology is further disclosed that includes multiple network-accessible computers coupled to a network. The network-accessible computers implement host computer programs that permit the network-accessible computers to operate as host computers for client computers that are also connected to the network. Accordingly, input devices associated with the client computers can be used to generate inputs to the host computers, such that holographic image information generated by the host computers can be viewed and/or manipulated by the client computers. The system also preferably includes a cluster administration computer coupled to the multiple network-accessible computers to monitor the operation of the network-accessible computers.

Access to the host computers by client computers, e.g., over a computer network, may be advantageously controlled and/or monitored. Thus, receipt of request(s) for access to a host computer that is coupled to a computer network by a client computer that is also coupled to the computer network is monitored. A suitable host computer for the client computer is determined, and the client computer is informed of the network address of the suitable host computer. The relationship of the host computer to the client computer is such that, after the client computer becomes associated with a host computer, an input device associated with the client computer can be used to generate inputs to the host computer. Holographic images generated by the host computer can also be viewed by the client computer.

A system/method for imaging the mouth area and adjacent lateral regions is contemplated for the purpose of producing reliable measurements of mouth and lip shapes for use in assisting the holographic speech recognition task. A specially equipped holographic imagery video camera is preferably arranged with a microphone to capture a lateral profile image of a speaker. The lateral profile image is then used to compute relevant features, such as lip separation, lip shape and intrusion depth parameters, to be displayed in the holographic imagery. The parameters are used in real time, i.e., during a speech recognition process, to characterize and discriminate spoken phonemes. Such real time processing helps to produce a high degree of accuracy in automatic speech recognition processing, and in transferring accurate holographic imagery over a computer and/or satellite network, especially in a noisy environment.

In continuous language recognition, reference languages and patterns of good quality are generated from the holographic database over a computerized network or satellite system. Continuous language patterns and reference language patterns are efficiently compressed so users can pick and choose language preferences that can be effectively converted for use in connection with holographic imagery preferences stored in a database. The compressed continuous language patterns are sequentially and directly matched with the compressed reference language patterns to recognize the language at high speed and with high precision. A reference pattern-generating unit generates a reference language pattern by normalizing sample patterns, while taking into consideration nonlinear compression/expansion, and by calculating an average of the sample patterns for input to the holographic imagery database system.

A continuous language recognition unit recognizes a continuous language at high speed by sequentially matching the continuous language of time sequential patterns with reference language patterns, while allowing nonlinear expansion and compression in the time domain. A language translation system is provided in which language, as well as the facial expression, movement or emotion of a language user, are recognized and converted into a holographic image. As a result, the captured image reflects emotion and movement, which are advantageously transferred in the form of holographic imagery texts, voices and/or sign language, to other individuals via a computer and/or satellite network or other communication system.

An interactive holographic imagery apparatus is also provided that operates to create holographic images, e.g., images having a fanciful holographic physical appearance, and includes at least one audio transducer, a transceiver communicating with the audio transducer, and a computer network. The computer network advantageously includes a user input receiver, a user information storage unit for storing information relating to a user's preferences received from a user via the user input receiver and relating to a user, and a computer transceiver. The computer network further includes a speech recognition unit for receiving speech input from the user and an interactive content controller that utilizes the information relating to the user's preferences received via the user input receiver and stored in the user information storage unit as well as the speech recognition output to provide interactive audio content to the user as part of an holographic image.

A system according to the present disclosure thus tracks human characteristics, including expression, body language, mental state, emotion, social intelligence, and/or eye/body movement, over time by analyzing a sequence of images. The tracked data is then transferred into images that are stored in a holographic imagery database. The system generally provides descriptions of the characteristics and motions between two holographic image frames. These descriptions of characteristics and motions are further analyzed by the system to recognize the aforementioned characteristics, movement and expression of the individual.

The system generally analyzes characteristics and motions between two images using parameterized models of image characteristics and motions. Initially, a first image in a sequence of images is segmented into a first region and a plurality of other regions. These regions are used to recover characteristics and motion parameters that estimate characteristics and motion between the segmented region in the first image and a second image in the sequence of images. The second image is warped or shifted back towards the first image using the estimated characteristics and motion parameters of the model, in order to model the characteristics and motions relative to the first image. A first model and a second model with curvature are typically used to recover characteristics and motion parameters that estimate the image characteristics and motion between the segmented characteristics/motions and within the various regions and images.

The recovered characteristics and motion parameters of the regions represent the relative characteristics and motions of the features between the first image and the second image. The region in the second image is tracked using the recovered characteristics and motion parameters of the region. The regions in the second image are tracked using both the recovered characteristics and motion parameters for the first region and the characteristics and motion parameters for the other regions. The parameters describing the characteristics and motion of the features are filtered to derive mid-level predicates that define body gestures occurring between the two images. These mid-level predicates are evaluated over time to characteristics, expressions and/or gestures that occur in the image sequence.

A control method according to the present disclosure for controlling operation of holographic image(s) generated by a user in an holographic environment includes: (i) defining emotions of the holographic image for deciding output of the holographic image, e.g., in relation to the user's state; (ii) formulating holographic image emotion generation algorithms to establish the relationship between the user's state and the emotions; (iii) formulating behavior decision algorithms to establish the relationship between input, including the emotions, and the behavior of the holographic image, (iv) detecting the user's state; (v) generating an emotional level for the object/image based on the user's state using the emotion generation algorithms; (vi) causing the holographic image to behave based on the user's state and the emotion using the behavior decision algorithms stored in the holographic imagery database system; (vii) evaluating reaction of the user in response to the behavior of the holographic image; and (viii) if the reaction of the user does not match the emotion of the holographic image in the emotion generation algorithm(s), adjusting at least either of the emotion generation algorithms or the behavior decision algorithms. Any such adjustments are preferably incorporated into future operations of the disclosed system.

The holographic image can detect and reflect the user's state in a visual, tactile, and auditory manner, as do humans in day-to-day life, and can act upon generation of emotions based thereon. Thus, natural communication between the user and the holographic image can be achieved, i.e., more human-like communication can be established.

Yet another aspect of the holographic imagery systems disclosed herein involves live holographic imagery transmissions over a computer or satellite network. Such live holographic imagery may include live holographic video over a computerized network, and may involve setting preferences for changing live holographic video format via pre-selected preferences stored within a database system.

A method/system for monitoring a conversation between a pair of speakers for detecting an emotion of at least one of the speakers is also provided. First, a voice signal is received by the system, after which a particular feature is extracted from the voice signal. An emotion associated with the voice signal is determined based on the extracted feature. The emotion is screened and feedback is provided only if the emotion is determined to be a negative emotion selected from the group of negative emotions consisting of anger, sadness, and fear. Such determined negative emotion(s) are then advantageously output to a third party during the conversation. While the emotion-detection method/system described herein focuses on negative emotions, the same procedures may be utilized for other emotional states, e.g., happiness, sadness, pain and the like.

Generally, buyers and/or service providers utilizing the disclosed method/system may remain anonymous up until such time as an agreement is consummated. It is further contemplated that buyers may remain anonymous even after the agreement is consummated by using a trusted third-party, e.g., the disclosed third party administrator, as a relay system for delivery/receipt of service(s) and or packages of services called for by the buyer's retaining offer/CRO. The method/system advantageously allows buyers/potential buyers to avoid being inundated with inquiries or acceptances from unqualified service providers, e.g., by ensuring that CROs are only dispatched to a limited number of qualified service providers. Thus, the identity of service providers is generally authenticated before CROs are provided by the retaining engine in order to determine/ensure the service provider's capacity to satisfy the conditions of potential (and specific) retaining offers.

Conversely, it is contemplated according to the present disclosure that service providers are safeguarded from unreliable retaining offers/CROs by authenticating the identity of the buyer and/or the integrity of the buyer's retaining offer/CRO. Service providers are generally allowed to submit authenticatable counteroffers to the buyer, and such counteroffers may be accepted by the buyer, thereby facilitating a contractual relationship between the service provider and the buyer pursuant to the authenticatable terms and conditions of such counteroffer.

In further preferred embodiments of the present disclosure, it is contemplated that digitally-based service(s) and or packages of services may be delivered, e.g., certificates of insurance from the service provider to the buyer, according to the terms of the buyer's retaining offer. In such circumstances, cryptographic validation of delivery of such insurance may be utilized. Alternatively, it is contemplated that retaining offers/CROs may be employed that allow more than one service provider to bind a buyer. Many aspects of the disclosed method/system may be practiced, in whole or in part, using non-electronic means, such as printed media or advertisements in newspapers, whether as a supplement to or replacement for electronic communications, e.g., over the Internet or the World Wide Web.

Having described certain aspects of the scope, functionality and benefits of the method/system of the present disclosure in general terms, attention will now be directed to describing aspects of the disclosed method/system in greater detail. According to one aspect of the disclosed method/system, a conditional retaining offer (CRO) management system is disclosed for receiving conditional retaining offers from one or more customers/users, and for evaluating the received CROs to determine whether a service provider, such as an accountant or medical service provider, might be willing to accept such CRO. According to the present disclosure, a CRO is a binding offer containing one or more conditions submitted by a customer/user for purposes of retaining service(s) and/or a package of services, such as home health care or hospice services, at a customer-defined fee.

In one embodiment, CROs are automatically evaluated against, i.e., compared to, a number of CRO rules defined by a plurality of service providers to determine whether the CROs satisfy the CRO rules for one or more such service providers. If a CRO satisfies the CRO rules for one or more service providers, then the management system concludes that such service providers may be willing to accept the CRO. According to this aspect of the present disclosure, a CRO rule is a set of restrictions or parameters defined by a given service provider, to define a combination of service-related restrictions pursuant to which the service provider is willing to accept a predefined minimum price. The CRO rules are utilized by the CRO management system to render a decision to accept, reject or counter a CRO on behalf of a particular service provider. The CRO rules may be generated, updated or revised by the retaining management system of respective service providers utilizing the disclosed method/system by evaluating current scheduling availability, inventory, pricing and revenue information, as well as historical patterns, to forecast future demand.

The CRO management system operates on conventional computer hardware systems, as are known in the art. The CRO management system generally includes at least one CRO management central retaining engine (RE)/server and one or more RE/secured servers. Each RE/secured server may be associated with one or more service providers and each RE/server stores, among other things, the CRO rules defined by the corresponding service provider(s). Each RE/secured server may be remotely located from the CRO management central RE/server, or may be integrated with the CRO management central RE/server. In one embodiment, the RE/secured server associated with one or more providers may be physically located at a hosting facility retained or secured by, or otherwise available to, the particular service provider. The CRO rules are preferably securely stored by each RE/server, to prevent one service provider from accessing, obtaining or altering the CRO rules of another service provider.

Once the terms of the CRO have been received by the CRO management system, the CRO management central RE/server determines whether one or more service providers will accept the received CRO, based on the then-current CRO rules for such service providers. Thereafter, based on such determination, the customer is notified of the response of the service providers to the CRO. Such response may include one or more counteroffers from service providers, based on criteria/parameters included with the CRO rules. If a service provider accepts the CRO, or if the customer accepts a counteroffer from a service provider, then the service(s) and/or package of services that were the subject of the CRO are retained by the CRO management system, i.e., recognized as a consummated transaction by the CRO management system, with the appropriate restrictions.

In a further embodiment of the present disclosure, if a CRO is accepted by more than one service provider, the CRO management system preferably executes a post-sell multi-bind process to permit each accepting service provider to directly market to the customer. In such multi-bind process, competing service providers have an opportunity to post-sell their service(s) and or package of services to the potential buyer, who is bound to accept at least one of the service providers based upon his/her CRO. Thus, the customer selects the most desirable service provider to utilize, based on materials or incentives furnished by such service providers and/or based on such other criteria as may be deemed relevant by the buyer, in his/her discretion. In short, the customer is bound by the CRO management system, in accordance with the terms of the CRO, and is obligated to retain the services specified by the CRO, but the buyer may decide which service provider to utilize, based on materials or incentives provided to the customer directly by each accepting service provider.

It is contemplated according to the method/system of the present disclosure that a CRO submitted by a customer may specify one or more preferred service providers. Thus, the CRO management system provides the CRO to each specified service provider to determine if one or more of the predetermined service providers are willing to accept the CRO. In this manner, the customer is able to establish an upfront filter for service providers that are eligible to provide the services of interest. The customer may periodically modify the predetermined list, at his/her option, e.g., if additional information becomes known concerning potential service provider(s).

In an alternative embodiment, the CRO management system preferably executes an excluded service provider CRO evaluation process to provide a customer's CRO to excluded service providers who may make counteroffers to the customer, in an attempt to obtain the customer's service business, before one of the customer's specified service providers accepts the CRO. The CRO can be provided to the excluded service providers before, or contemporaneously with, the preferred service providers. In this manner, the CRO management system can utilize the rights to receive CRO information with respect to excluded service providers, as may be appropriate, or collect a larger percentage for any counteroffers that are accepted by a customer from an otherwise excluded from the pool of acceptable service providers. It is contemplated that a customer may be permitted to opt-out of the excluded service provider CRO evaluation process, if desired.

The CRO management system preferably allows a number of service providers to conditionally accept each CRO. In this manner, the CRO management system can ensure that at least one of the accepting service providers will have the available service in the condition specified by the buyer. Preferably, each of the accepting service provider(s) is prioritized into a hierarchy based on predetermined criteria. Thus, the authenticator functionality will evaluate the service(s) and or packages of services received from each service provider in the hierarchy, in the appropriate order, until the proposed service(s) are in the condition specified by the buyer in the CRO. For example, service providers may be assigned a priority in the hierarchy based on the order in which their acceptances are received by the CRO management system. Alternatively, the assigned priority may be based on the performance of each accepting service provider in performing previous services to customers. As a further alternative, priority may be established based on the geographical proximity of each accepting service provider to the buyer. Combinations of the foregoing criteria, and alternative criteria (e.g., an averaging algorithm that seeks to spread the consummated transactions among all service providers evenly), may be employed to prioritize acceptances received from service providers.

The CRO rules generally contain sensitive information, including price flexibility and available scheduling, which, if known to a service provider's competitors or customers, could dramatically impact the service provider's overall revenue structure and/or competitive position in the marketplace. Thus, according to a preferred feature of the disclosed method/system, the CRO rules are securely stored. Regardless of where the CRO rules are hosted, e.g., on a service provider's computer system, at an ASP, or at a third party data center, the CRO rules are securely stored by each service provider RE/server, thereby preventing one service provider from accessing, obtaining or altering the CRO rules of another service provider. In one embodiment, the secured SP RE/servers utilize encryption techniques and database access control mechanisms, as are known in the art, to protect each service provider's CRO rules from undesired access by third parties.

According to a further preferred aspect of the disclosed method/system, the CRO management system includes functionality that advantageously prevents customers from submitting multiple CROs containing progressively increasing prices in order to identify the service provider's defined minimum retainer/price for given service(s) and/or package of services. In one embodiment of the present disclosure, “anti-pinging” functionality is achieved through the binding nature of a customer's CRO. Thus, a CRO submitted to the CRO management system by a potential customer is automatically binding, if accepted by any service provider, thereby discouraging customers from “pinging” the CRO management system to identify the service provider's underlying price flexibility. In addition, the CRO management system preferably includes functionality that limits the number of CROs that any customer can submit within a predefined time period. In this way, service providers are supplied with invaluable protection from repeated customer requests aimed at determining a pricing floor.

To maximize the convenience and accessibility of the disclosed method/system, it is contemplated that customers may contact the CRO management system by means of telephone, facsimile, online access, e-mail, and/or in-person contact, either directly or through an agent, to provide the CRO management system with the terms of their CROs. In one preferred embodiment, the customer may contact the CRO management system by means of a telephone, with the CRO management system collecting information from the customer related to the CRO using an interactive virtual personal assistant, e.g., a holographic image. Once the terms of the CRO have been received by the CRO management system, the CRO management central RE/server will execute a CRO management process to compare the received CRO against the CRO rules of each participating service provider, to determine whether to accept, reject or counter the submitted CRO. Thereafter, the customer is generally notified of the response of the service providers to the CRO by one of the means of communication set forth above, e.g., telephone, facsimile, online access and/or e-mail. If a service provider accepts the customer's CRO, or if the customer accepts a counteroffer from a service provider, a consummated transaction is established and service(s) and/or a package of services are then retained by the CRO management system with the appropriate restrictions associated with the customer's CRO.

The CRO management system may optionally access a central retaining system or proprietary service provider retaining and scheduling system for one or more participating service providers. Through such access, the CRO management system may advantageously perform analyses associated with determining the feasibility and/or optimal characteristics of service supply in response to a customer CRO. For example, the CRO management system may access a service provider-related database to make itinerary queries to identify particular services and/or packages of services that satisfy a customer's requested itinerary (as reflected in a CRO). Based on the results thereof, the CRO management system may advantageously make scheduling arrangements and/or retaining of services with a “retain now” feature of the retaining engine.

In a further preferred embodiment of the disclosed method/system prospective customers and/or clients are provided with the ability to retain services and/or packages of services by easily and reliably communicating a binding retaining offer/CRO to potential service providers on a global basis, while at the same time service providers are able to conveniently search for relevant retaining offers/CROs from potential customers/clients. The ability to search outstanding/current CROs provides participating service providers with a valuable ability to leverage excess service capacity in real time. As noted previously, service providers are able to bind a potential customer/client to a contractual relationship based on the customer's/client's retaining offer/CRO. Additionally, the disclosed method/system can contribute to effectuating performance of an agreement between a customer/client and a service provider, e.g., by guaranteeing and/or facilitating customer/client retainer/payment of retainer for the service(s) and/or packages of services that are the subject of the CRO. The present disclosure thus provides a highly effective bilateral, buyer-driven commerce retaining system that improves the ability of customers to reach/communicate with service providers capable of satisfying the customer's retaining needs, and that improves service providers' abilities to identify and communicate with potentially interested customers/clients.

In a preferred embodiment of the present disclosure, communications between potential customers and service providers are accomplished/conducted via an electronic network and central retaining engine controller. A customer who wishes to retain service(s) and/or a package of services electronically accesses the central retaining engine controller located at a remote RE/server. The customer creates a conditional retaining offer/CRO by specifying the service(s) and/or package of services of interest, including relevant descriptive information and conditions associated with the customer's/client's request.

The customer generally attaches and/or enters an user identification or other user identification indicia as part of the CRO and transmits the CRO to the central retaining engine controller. The CRO may be transmitted to the retaining engine controller through a variety of communication means, e.g., via a World Wide Web interface, electronic mail, voice mail, facsimile and/or postal mail. Standard legal provisions and language are then integrated with the CRO by the retaining engine controller to “fill in the gaps” of the customer's retaining offer/CRO. Alternatively, the CRO may be developed while the customer is on-line with the central RF controller. In a preferred embodiment of the present disclosure, the customer is provided with an opportunity to ratify the CRO, including any gap-filling provisions, to ensure the potential enforceability thereof.

Before communicating the CRO to potential service providers, the central RE controller advantageously authenticates the customer's user identification number or applicable user identification indicia against a customer/client database maintained by the RE controller. The central retaining engine controller may additionally require that the customer provide a credit card number to secure/fund the CRO, and may undertake appropriate investigation to ensure that the customer has sufficient credit available to cover the retainer specified in the CRO, e.g., by contacting the credit card clearinghouse. Upon completion of the required customer authentication/credit investigation, the central RE controller generally assigns a unique tracking number to the CRO and globally displays the CRO in a manner such that it is available to be viewed by any interested potential service providers (subject to restrictions imposed by the customer).

CROs may be advantageously displayed according to the present disclosure in a manner that facilitates ready access by interested parties. Thus, CROs may be displayed by subject matter, community category, date of request, potential contract value and/or combinations thereof, to make it easier for potential service providers to identify relevant CROs. It is further contemplated that CROs may be advantageously displayed in multiple categories, as appropriate, to ensure maximum visibility to interested parties. Thus, a service provider is able to log onto a Web site associated with the disclosed method/system, for example, and see, inter alia., a listing of CRO subject and/or community categories. The service provider may choose a particular subject and/or community of interest, and have the ability to browse CROs that correspond to that subject or community category. In a preferred embodiment according to the present disclosure, the service provider may be required to provide qualifications (e.g., user name and password that is checked against a service provider database) in order to view the CROs of a given subject or community category.

If, after reviewing a particular CRO, a potential service provider wishes to accept the CRO, the service provider communicates its intent to the central retaining engine controller. The central retaining engine controller timestamps the message from the service provider for future reference, e.g., in situations where a hierarchy is established among service providers based on timeliness of response. The controller further authenticates the identity of the service provider and/or authority of the individual acting on behalf of the service provider, as well as such service provider's capacity to deliver the service(s) and/or package of services sought by the customer/client. The disclosed method/system typically verifies that the particular CRO is still “active” and capable of being accepted by the service provider. For example, if a CRO is capable of being accepted only by one service provider, it is “completed” when the first qualified service provider accepts it. Subsequent service providers will generally not be able to accept a “completed” CRO. If a SP accepts an active CRO, a unique tracking number is assigned to the SP's acceptance, although back-up acceptances from additional service providers are contemplated. The service provider's acceptance of the CRO is then stored in a database, the customer is notified of the CRO's acceptance, and the customer and service provider are now parties to a binding agreement based on the terms of the CRO.

In another embodiment of the present disclosure, the central retaining engine controller additionally, automatically manages the payment retaining system between the customer and the service provider. Various methods of payment and or retainer may be utilized according to the disclosed method/system, including credit cards, personal checks, electronic funds transfer, debit cards, and digital cash. Alternatively, the customer may be billed/invoiced. The payment retaining system may also involve the creation and use of an escrow account associated with the customer, wherein funds advanced by the customer to cover the retaining of desired service(s) and/or packages of services are tracked and maintained by the controller pending acceptance of CRO(s) by qualified service providers. Moreover, the timing of payment and/or retainer amounts to service providers may vary from CRO to CRO and, in certain circumstances, the service provider may be paid immediately after the service provider accepts a CRO, or payment may be delayed until after the service provider performs all, or substantially all, obligations under the CRO.

In yet another embodiment of the present disclosure, a service provider has an option as to accepting a CRO, as presented by the potential buyer, or responding to such CRO by issuing a binding counteroffer that includes one or more terms/conditions that are different from the original CRO. The service provider generally transmits the counteroffer to the central retaining engine controller, which then forwards the counteroffer to the potential buyer/customer. The customer is then given the option of accepting the counteroffer, responding with a further counter, or declining the service provider's counteroffer.

According to the present disclosure, it is contemplated that all or parts of the disclosed method/system may be advantageously practiced off-line. Thus, rather than using electronic mail, Web-based servers or other electronic communication systems, customers and service providers may communicate with the central retaining engine controller via telephone, facsimile, postal mail and/or other off-line communication tool. For example, customers may use telephones to create CROs (with or without the assistance of live agents) and potential service providers may use a telephone to browse and bind CROs. Thus, the advantages of the disclosed method/system are susceptible to a broad range of applications.

In another on-line embodiment of the present disclosure, cryptographic protocols are advantageously used to authenticate the identity of customers and/or service providers. Such cryptographic techniques may be used to verify the integrity of customer and service provider communications with the central retaining engine controller. Using cryptography and/or biometrics, the impenetrability of the central retaining engine may be increased by making it significantly more difficult for unauthorized persons to tamper with the disclosed method/system by passing themselves off as legitimate customers and/or service providers, or otherwise eavesdropping on or interfering with system communications.

Anonymity is another advantage of the method/system of the present disclosure. For numerous privacy and competitive reasons, customers and service providers often prefer not to have their identities revealed to the general public when engaging in commercial transactions. The disclosed method/system advantageously protects the anonymity of customers and/or service providers, e.g., through the use of identification numbers/indicia securely stored in database(s) within the central retaining engine controller.

From a hardware perspective, the method/system of the present disclosure may be divided/deployed such that the functionality of the central retaining engine controller is spread across numerous hardware components. For example, the retaining engine controller according to the present disclosure may comprise numerous separate retaining engine servers, e.g., an operations RE server, a trusted RE server, and a bonding agency server. As disclosed herein, the trusted RE server is programmed to authenticate the identity of customers and/or service providers, while the bonding agency server is programmed to verify the ability of customers and/or service providers to pay, deliver or schedule the service(s) and/or package of services embodied within applicable CROs. An operations RE server posts the CRO, relying upon messages from the other RE servers for appropriate validation checks of associated databases. This configuration allows for greater specialization of the RE servers, increasing flexibility and scalability of the disclosed method/system.

In a further embodiment of the present disclosure, a transfer of money from a customer to a service provider is not required in connection with a CRO. Instead, the disclosed method/system may be used to consummate a contractual relationship involving an exchange of services and/or packages of services, e.g., a barter relationship, and/or the exchange of other non-monetary consideration.

According to additional preferred embodiments of the present disclosure, a mechanism for resolving disputes between customers and service providers arising out of agreements consummated using the disclosed method/system is contemplated. For example, parties may be required and/or encouraged in CROs to stipulate to binding arbitration and may be assisted in the arbitration process by the central retaining engine controller. Thus, the central retaining engine controller may serve as an arbitrator, or may refer the dispute to a third-party arbitrator for resolution, whether via electronic communication or other dispute resolution modality.

The present disclosure thus provides preferred embodiments in which a computer-implemented method/system for facilitating the negotiation and/or performance of continuous retaining auctions over a computer network The method/system preferably utilizes a “retaining engine” that permits service providers and multiple potential clients/buyers for the services offered by the service providers to communicate concerning the clients/buyers retaining such services. The retaining engine advantageously facilitates an auction-based retaining model that offers services via an auction format, with instant retaining capabilities for retaining service providers. Potential buyers/customers provide customer input data relating to particular services or package of services desired to be purchased from service provider(s).

The method/system of the present disclosure further contemplates referrals of service providers to other businesses, colleagues, family and friends using a “business service referral engine.” The disclosed method/system also offers significant functionality within the realm of employment services, offering “hire now” capabilities for individuals and employers interested in locating mutually beneficial employment opportunities.

The disclosed method/system also provides an advantageous information presentation and management mechanism for an online retailing environment. Thus, in preferred aspects of the present disclosure, person-to-person or business-to-consumer commerce over the Internet or the World Wide Web is facilitated by providing prospective buyers the ability to quickly preview services that are available from service providers and readily retained by the prospective buyers. Descriptions of services or packages of services and/or videotapes describing services are preferably obtained from a plurality of service providers or sites, e.g., based upon service provider-supplied information. The service provider-supplied information may include descriptions of services or packages of services available and locations from which services or packages of services can be retained.

In preferred embodiments, the descriptions and/or videotapes associated with available services may be accessible to potential buyers via hyperlinks and/or aggregated onto a Web page for presentation at a dedicated site. According to another aspect of the present disclosure, a user/potential buyer may submit a query to preview services or packages of services that are available for purchase. After receiving a query, descriptions and/or videotapes corresponding to the services or packages of services that satisfy the user query may be advantageously transmitted/displayed for viewing by the interested individual.

Thus, in a preferred method/system according to the present disclosure, service(s) and/or package of services may be retained from service provider(s) using a retaining engine that advantageously displays information identifying and/or concerning the service(s) and/or package of services of interest and facilitates retention of such service(s)/package of services in response to a single action being performed by the user/potential buyer, namely, sending a request to retain the service(s) along with identification information/indicia for the purchaser/retainer to a retaining engine/server system The retaining engine/server system advantageously receives the request for services from the user/potential buyer, e.g., through electronic communication over the Internet or the World Wide Web, and retrieves appropriate information associated with the user/potential buyer that was collected in connection with the information request transmitted to the service provider. Moreover, the disclosed method/system generates a retainer to retain the requested service(s) and/or package of services for the user/prospective purchaser, and optionally tracks/monitors the service provider's performance of the service(s) through completion, e.g., to facilitate payment to the service provider at the appropriate juncture. Of note, the disclosed method/system facilitates retention of service(s)/packages of services by users/purchasers without using a shopping cart ordering model.

The disclosed method/system may utilize conventional keyboard entry of information/queries/commands and the lie by the user/potential purchaser. Alternatively, communication with the retaining engine of the present disclosure may be achieved through voice recognition/voice command technology and/or other verbal/audible technologies that are designed to translate sound into electronic communications over a computer network.

In certain preferred embodiments of the present disclosure, a user/potential purchaser need not explicitly identify himself/herself when interacting with the retaining engine of the disclosed method/system, e.g., when retaining service(s) and/or requesting additional information. Thus, in a further embodiment of the present disclosure, a retaining engine for retaining service(s) and/or packages of services is provided, the retaining engine communicating with a database that contains identifier(s) that identify user(s)/potential customer(s). The identifiers may be based upon IP addresses for user(s)/potential customer(s), user name/password combinations, and the like. The retaining engine further communicates with a display component that is programmed to display information identifying and/or concerning service(s) and/or packages of services available for purchase using the retaining engine. The display component is typically a Web browser, e.g., commercial browsers such as Netscape Navigator or Internet Explorer, and generally results in display of HTML pages, video/audio streams and the like.

A single-action retaining component is advantageously provided that transmits a request to a retailing engine system to retain the identified service(s) and/or packages of services in response to a single action on the part of a user/potential customer. Thus, to facilitate the retaining process, the request typically includes and/or is tagged with the user's/potential customer's identifier so that the retaining engine system can locate additional information needed to complete the retainer, e.g., check creditworthiness and the like. In addition, receipt of the identifier allows the retaining engine system to complete the generated retainer to complete purchase of the service(s) and/or package of services by the user/customer.

The disclosed method/system further provides a retaining engine system for retaining a service(s) and/or packages of services that includes a “services wanted cart retainer component” that a user/potential customer is able to utilize, e.g., across a computer network such as the Internet or the World Wide Web. The method/system preferably allows a user/potential customer to retain service(s)/package(s) of services through a single-action. The single-action retention of services is preferably facilitated through a retaining component that includes a data storage medium storing information concerning a plurality of users/potential customers and a receiving component for receiving requests for services to retain service(s) and/or package(s) of services. The requests generally include an identifier and/or indicia for the individual user/potential customer, such identifier/indicia permitting the retaining engine to recognize the user/potential customer based on information previously collected and stored in the data storage medium.

The retainer for services component advantageously searches for and retrieves relevant information concerning the user/potential customer from the data storage medium The retrieved information is generally used to facilitate processing of such user's/potential purchaser's retention of service(s)/package(s) of services. The disclosed method/system further generally includes a retainer fulfillment component that completes a purchase of service(s)/package of services in accordance with the retainer placed by the single-action retaining component. Thus, the disclosed method/system facilitates rapid, reliable and efficient interactions and communications in connection with a user's/potential purchaser's retention of service(s) from service provider(s).

A method for retaining service(s) and/or packages of services is further provided here in which a retaining engine system is utilized, inter alia., to display information identifying service(s) and/or packages of services that are available to be retained by a user/potential customer. The retaining engine system further displays an indication and/or prompt as to a single action that is to be performed by a user/potential customer to retain the displayed service(s)/package of services. The retaining engine system transmits a request in response to only the indicated/prompted single action on the part of the user/potential customer, such transmission generally entailing retention of service(s)/package(s) of services by the user/potential customer. Thus, the retaining engine system advantageously operates to to facilitate retention of service(s)/package(s) of services without utilizing a shopping cart model. The disclosed method/system may advantageously transmit a combination to the user/customer that the retainer/request was generated and that the service(s)/package(s) of services have been retained.

With particular reference to the single action(s) that may be undertaken by a user/potential purchaser and recognized by the retaining engine system, a host of possibilities are contemplated. Thus, for example, it is contemplated that the single action may involve clicking a mouse button when a cursor is positioned over a predefined area of displayed information, giving a voice command or otherwise generating an appropriate sound, transmitting infrared or other high frequency energy, e.g., using a television remote control, depressing a key on a keypad, using a pointing device, pressing a touch surface on the displayed indication, and combinations thereof Thus, it is contemplated that any known mechanism for generating a signal to the retaining engine system may be successfully and effectively employed according to the method/system of the present disclosure.

The disclosed method/system further provides for displaying partial information supplied by the retaining engaging system as to the identity of a user/potential purchaser utilizing the retaining engine/client system For example, a partial display may include partial shipping information supplied by the retaining engine system, partial payment information supplied by the retaining engine system, and/or a shipping address for the customer. This partial information may be useful in allowing a user/potential purchaser to confirm his/her identity and/or relevant information in advance of consummating the purchase of service(s)/package(s) of services according to the present disclosure.

The disclosed method/system is particularly advantageous in computer-implemented embodiments that allow consumers to search by service and/or geographical location, e.g., state or zip code, for the services they desire. Thus, a software interface may be provided that facilitates organization of information predicated upon the geographical area and/or geographical parameters associated with the resources/services of interest. In a preferred embodiment, a user/potential customer may be presented with several navigational options, e.g., a “viewpoint” map, zip code index, city/state drop-down menu, and the like, to facilitate location of desired service(s)/service provider(s). A “viewpoint map” may include, for example, an actual visually displayed map of a selected geographical area and/or text information pertaining to the resources/services/service providers of interest.

A geography database, a local content database and/or a yellow pages database may be advantageously provided according to the present disclosure to allow user(s)/potential customer(s) to obtain relevant information, e.g., information at different levels of geographic detail. The geography database allows the user to browse through different geographic areas that are hierarchically ordered/organized. A local content database may advantageously include information about services available within a given geographic location and the yellow pages database generally includes information about specific services in the geographic location. Thus, a user/potential customer is provided with a readily available mechanism in which information associated with particular geographic locations is readily accessed, analyzed and utilized This geographic breakdown functionality may be a particularly valuable added benefit for rural and smaller community service providers, and/or to service providers that offer delivery and/or pick up.

A computer-implemented method/system according to the present disclosure advantageously allows competitive bidding for all types of services/packages of services. While computer implementation offers many benefits to the disclosed method/system, it is contemplated that communications associated with the disclosed method/system may not only be achieved via computer networks, e.g., using the Internet and/or the World Wide Web, but also may be achieved, in whole or in part, via facsimile, courier transmissions, postal services, and the like. Thus, the present disclosure offers a new and highly beneficial mechanism for conveniently, efficiently and cost effectively outsourcing services from service providers.

In further preferred embodiments of the present disclosure, a computer-implemented system for retaining services is provided in which an interface mechanism allows a user/customer to input data relating to retaining and/or purchasing particular service(s)/package(s) of services. The computer-implemented system preferably includes a “retain-now” feature or functionality that allows a user/customer to instantly retain a service provider to supply requested services at an agreed upon price. Thus, a “retain-now” feature instantaneously effectuates a sale for particular service(s)/package(s) of services at a specific price, and can be particularly advantageous when multiple service providers respond to a user's/customer's request for services. Thus, for example, a user/customer may advantageously employ a “retain-now” feature based on more desirable geographic location for a local service provider, e.g., based on city/state and/or zip code information. Of note, the computer-implemented system may advantageously store user/customer profile data and historical customer result data, e.g., to facilitate data mining, statistics reporting and analysis, and related market research, as is known in the art.

In deploying a computer-implemented system according to the present disclosure, it is contemplated that a variety of network topologies may be employed to advantage. Thus, data transmission across networks, e.g., a distributed computer network such as the Internet and/or the World Wide Web, is encompassed within the present disclosure. It is further contemplated that networked data transmissions may be achieved via local area and wide area networks, i.e., LANs and WANs, as are known in the art. Interfacing with the computer network may be achieved through conventional means, e.g., conventional Web browsers and/or similar interfaces.

The computer-implemented system according to the present disclosure advantageously posts proposal(s)/request(s) for service(s)/package(s) of services on the Internet for review, consideration and potential acceptance by service providers. Moreover, the disclosed system generally processes and/or tracks financial transactions and other business relationships between buyers and service providers associated with the posted proposals/requests. The disclosed “retaining engine” methodology and associated system thus provides users/potential customers and service providers with direct and extensive control over business transactions on the Internet.

The user/customer base for the “retaining engine” methodology and associated system according to the present disclosure is wide-ranging. For example, retaining engine services can be effectively used by large corporations that want to integrate open and scalable retaining engine capabilities into their existing Web sites and business models. Similarly, service providers can customize their participation with a retaining engine according to the present disclosure, e.g., with unique user interfaces and supplemental differentiating applications.

A preferred method/system according to the present disclosure thus provides one or more retaining engine computer systems for facilitating electronic commerce over a network between a plurality of sellers and buyers, each of such sellers/buyers accessing the retaining engine computer system through appropriate computer system(s), e.g., a personal computer, PDA, cellular phone and the like. The method/system involves displaying a registration Web page to a remote service provider computer that accesses the Web page over a network, e.g., a LAN, WAN, the Internet, the World Wide Web, etc. In response to the registration page, the retaining engine computer system advantageously receives registration(s) from such service provider for service(s) and/or package(s) of services available from or through the service provider from the service provider computer over the network The registration generally includes description(s) of the service(s)/package(s) of services, and optionally further includes a Universal Resource Locator (URL) indicating a Web-based location for additional information concerning the service(s)/package(s) of services, e.g., images, video files, audio files, and/or narrative descriptions related thereto. The Web-based location generally functions as a hyperlink to the hosted location of the desired additional information, e.g., on the service provider's computer system and/or a third party's computer system, that communicates with the network.

According to the disclosed method/system, it is contemplated that a plurality of service providers will be provided with comparable registration Web pages, and will supply registration information and ancillary information concerning services to be offered through the disclosed method/system, e.g., by providing hyperlinks to promotional and/or informational materials hosted on computer systems that communicate with the appropriate network, e.g., the Internet or the World Wide Web. Thus, the disclosed method/system will receive a multiplicity of registrations from a multiplicity of service providers, thereby creating a “catalog” to of available service(s)/package(s) of services for review and potential purchase by users. Thus, users are able to retrieve and review information concerning services available according to the disclosed method/system in connection with potential purchasing decisions. It is further contemplated according to the present disclosure that informational materials related to competing service offerings may be combined in a single Web page presentations, for simultaneous viewing by potential purchasers. The combination may be achieved in response to user requests, or in anticipation of user requests to facilitate the purchasing process.

The creation of customized Web pages to facilitate side-by-side viewing by potential buyers offers significant efficiencies and advantages to potential buyers. Thus, in situations where two sets of informational material are to be displayed side-by-side, it is contemplated that the images may be comparably sized so as to offer equivalent views to the respective offerings. Such sizing of Web page images is typically accomplished through conventional content management systems, as are known in the art.

Retaining engine systems according to the present disclosure advantageously permit service providers to host one or more auctions and/or “retain now” features and/or retaining engine galleries. Thus, users/potential customers may manage their retaining engine auction gallery independently of any other galleries that the service provider may be simultaneously hosting. In preferred embodiments of the disclosed method/system, the retaining engine architecture is created with “open” programming, thereby permitting system integrators and other third parties to create special purpose add-ons for use in conjunction with the retaining engine system Such add-ons and third party programming contributions generally serve to improve the performance and functionality of computer-based systems in a steady, reliable and cost effective manner.

The retaining engine system generally provides a rich set of features in connection with APIs and programming code associated therewith, including cross-platform and language-independent support for various system softwares, e.g., Windows NT and Solaris platforms, open connectivity to relational databases, such as Informix, Oracle8 and SQL Server, and/or open connectivity to invoicing and billing modules. The retaining engine system generally includes a hierarchical user-privilege model that offers optimal usage controls. Further features and functionalities generally associated with retaining engine systems according to the present disclosure include integration point(s) for SMTP server(s) to facilitate e-mail transmissions to system users and administrators, and other communication modalities, e.g., an ability to notify wireless devices and Personal Digital Assistants (PDAs) of relevant information, as well as an ability to send notices to buyers and sellers about relevant retaining engine system activities. Thus, alternative communication modalities include phone, cellular phone, facsimile and/or instant messaging. Such communications may be particularly useful to parties utilizing the retaining engine system, e.g., when it is desirable to communicate a need to bid higher or “retain now” to achieve desired objectives.

The present disclosure further provides a computer-implemented method/system for retaining service(s) or packages of services from a plurality of service providers by customs utilizing a retaining engine system Such plurality of service providers may advantageously implement co-branding and/or the formulation of integrated service solutions that better service customers and potential customers. Thus, the disclosed method/system may receive listings of services and/or packages of services from service providers that may be effectively combined and/or co-branded Similarly, the disclosed method/system may receive customer input relating to particular services or packages of services that are desired, and may identify an opportunity to fulfill such requirements through combined and/or co-branded solutions derived from multiple service providers. For example, such services may not be effectively broken into individual geographic locations, instead requiring service providers in multiple locations. Such situations present a unique opportunity to combine/leverage the capabilities of individual service providers to mutual benefit, and to the benefit of prospective purchasers.

A further advantageous functionality associated with the method/system of the present disclosure relates to an ability to collect and report valuable user information for analysis by service providers and other market-related entities. Thus, it is contemplated that customer profile data, historical customer result data, and customer behavior patterns will be tracked, e.g., through conventional Web site log reports, and stored for reporting and analytical purposes. In addition, it is contemplated that service provider data will be tracked and stored, e.g., across different services, to gain valuable data mining capabilities wit respect to service providers and/or particular categories of services and/or service packages. Valuable information concerning user/potential purchaser behavior in formatting, submitting and responding to offers for services may provide important insights to improve marketing, promotional, pricing and value-added service strategies.

The disclosed method/system further provides a computer system that includes a computer readable medium having computer readable programming code installed thereon, such programming code facilitating negotiations related to retaining services and/or packages of services by customers utilizing a retaining engine. The programming code guides users and service providers through one or more of the registration process, the offer submission process, to the offer acceptance process, the hierarchical handling of multiple service provider acceptances, and/or the performance-related steps subsequent to creation of a contractual relationship between a user and a service provider. Thus, the disclosed computer system facilitates outsourcing of services by service providers, and the acquisition of such outsourced services by users of such services, i.e., the creation of a new and beneficial distribution channel for services.

According to alternative embodiments of the present disclosure, consumers are empowered to competitively bid for all types of services or packages of services from service providers that can include “package deals,” e.g., forty hours of transcription, secretarial and/or paralegal services, and/or medical billing services that would be cumulatively performed via a “virtual personal assistant” over a distributed computer network, such as the Internet, or in a specific geographical location. Thus, the disclosed method/system allows the creation of “service cooperatives” that jointly offer a variety of services, and share revenues associated with sales thereof on a predetermined basis, e.g., hours actually expended versus total hours acquired by the user. Such blended systems allow further elimination and/or reductions in fixed and pre-determined pricing, allowing the market to establish pricing based on classic supply and demand.

The disclosed method/system as a unified system thus provides significant benefits not presently available in the services marketplace, including the ability to: collect marketing data on existing and potential buyers; attract additional traffic to business Web sites; to attract additional traffic to geographical on site businesses; and lengthen Web sites visits. The disclosed method/system further permits service providers to reduce the price of materials and services, achieve shorter transaction & fulfillment cycles, and lower administrative costs. Consumers of services also realize significant benefits, including the ability to: efficiently discover pricing parameters for desired services; improve control over off-contract purchases; and reduced inventory holding costs. The disclosed method/system provides an online marketplace through which buyers and service provider's worldwide can exchange information, source services, and execute online retaining. The global marketplace allows the delivery of targeted content, access to focused audiences, and interactions with qualified sales leads. It further allows buyers to source and compare complex services online, while allowing service provider's to participate in e-commerce without developing or expanding a costly infrastructure.

According to preferred embodiments of the present disclosure, ancillary beneficial and/or advantageous features/functionalities may be provided and/or deployed, including access to cost estimates for services, access to liquidation auctions, reserve pricing, specialty sites, business exchanges, charity exchanges, classified ads, expedited emergency services or “should have been done yesterday” service request, rating service provider forms, data mining capabilities with add on features, ability to link other sites and networks in a retaining engine auction, credit card processing, category setup, advanced import/export utility, invoicing and billing modules, multi-lingual communications, service provider to refer to a friend or colleague, chat rooms, bulletin boards, video and audio interaction, sweepstakes for services, where is a service, where is a local service or service provider, retaining within (so many miles) radius, retract my bid, custom audio and video welcome/greeting (“welcome back Tim”), corporate retaining engine services, reviews and online discussions with audio and video technologies between satisfied customers, face to face contact with service provider's out of your region or geographical location using audio and video technologies, and/or customer rewards and customer retention points programs.

In the area of referrals, the disclosed method/system contemplates an Internet-based referral system that enables individuals and other business entities to refer service provider's services and/or packages of services to third parties. Thus, in association with each service provider/services, a hypertextual “referral link” is optionally provided that allows a user (“customer”) to link the service provider's site and/or services to colleagues, friends and family. When a customer selects a referral link, the customer's computer generally transmits unique IDs for the selected services and for the service provider's site, allowing the service provider to identify the underlying service and the referring user. If the referred individual subsequently retains the services from the service provider's site, a system (e.g., a point system) may be employed to automatically credit the referring individual's account with a given point level. Thereafter, when that individual's credited account reaches a certain limit or range, then that individual may advantageously qualify for free services (or other reward) from the service provider.

To facilitate efficient processing, a preferred embodiment according to the present disclosure operates such that an electronic shopping/retaining cart is activated that allows the customer to select services and or packages of services from multiple, different service provider Web sites, and then perform a single “retain now” feature from all of the service providers' sites simultaneously.

Examples of services that might be simultaneously retained from multiple service provider sites include legal services, research services, tax services, virtual personal assistants, administrative services, data entry services, internet services, medical support services, staffing services, virtual office services, and the like.

Through the direct interaction between the retaining engine system and individual customers/service providers, an understanding of the individual needs and interests of individual users of the system may be developed. Thus, one-to-one personalized marketing that delivers custom e-mail offers and other individualized communications may be undertaken. These messages entice ongoing response by describing services that meet specific user service preferences, needs and interests.

A charitable feature/functionality associated with preferred embodiments of the present disclosure facilitates donations by service providers of free services for those in need. Such donations may be accomplished over the Internet or through local area and region agencies. The charitable feature/functionality contemplates that a charity request may be received about a party (not limited to an individual or family) that is in need of services or packages of services in a geographical location. Based on surplus capacity that remains unused, despite postings on the retaining engine system, may be dedicated to fulfilling such charitable requirements, at the discretion of the service provider(s).

To facilitate evaluation by potential purchasers/customers, each service or package of services listed for purchase using the retaining engine system generally includes a variety of background information, including, e.g., specific service and/or service package details, consumer reviews and other in-depth information on the service/package, information allowing a potential purchaser to communicate with a third party concerning the particular service/package (e.g., by e-mail, audio or video), and/or links to service providers' Web sites. Additional information may include links to other sites to check other services the service provider may offer, in addition to the auction services or secure discounted services, access to guest speaker or service provider videos, top links by category, Web cams from key service providers around the world, and trained service consultants in each category to assist customers, e.g., by way of live chat, phone, audio, video and/or e-mail. Moreover, it is contemplated that a growing database of consumer service provider reviews may be developed to assist purchasers/customers.

Further features/functionalities that are contemplated according to preferred embodiments of the present disclosure include mystery shopping and/or retaining reports on selected services, personalized weekly HTML services for auction e-mail newsletter to registered bidders, specific service management strategies matching consumer buying habits to geographic and demographic profiles, exclusive silent/private retaining engine auctions through “invitation only,” personal business pages and instant messaging, and category-specific discussion groups that integrate audiences from service related sites. The disclosed method/system may further include an ability to personalize a user's personal computer based on a professional service theme (e.g., wallpaper, custom cursors and/or screen savers), and/or the inclusion of “no bid” retain now options that allow consumers to retain discounted services and/or consolation offers that provide losing bidders with similar service(s) outside of the auction.

The retaining engine system can be installed directly on a service provider's Web site. Deployment on a service provider's site allows the service provider to manage its own postings/auctions and/or become a co-branded, infrastructure site. The service provider may also communicate services directly to the master retaining engine system.

With particular reference to the auction aspects of the present disclosure, the retaining engine system generally has the ability to set maximum bid prices, thereby allowing the system to automatically update each customer's bid. The disclosed method/system also advantageously transmits e-mail notifications when customers have been outbid, and confirmation and congratulatory e-mail communications for wining bids. Weekly e-mail and/or notification campaigns may be undertaken to apprise registered bidders of upcoming services, including guest speaker availability and exclusive silent/private auction events. E-mail transmission of newsletters designed to meet users' specific needs and requests are also contemplated.

Significant targeting of content, promotional materials and communications is thus possible according to the present disclosure. For example, demographic analysis may be used to guide the display of featured services that fit an individual or company profile of interests and past service requests. The disclosed method/system may advantageously present pictures, audio and/or video according to the demographic profile of a user, target engaging content for a user based on interest profiles, create new auction lots that would appeal to an individual user, suggest special services/packages based on known anniversaries, birthdays and special events, and/or create and market special services/packages based on a consumer's geographic location (e.g., 24 hour services, emergency instant services, in home services).

In preferred embodiments of the present disclosure, a neural network-based data mining technology is utilized to enable users to create sophisticated predictive models of complex market forces and customer behavior. The method/system thus permits models to be built that not only reflect past historical services/packages and events/transactions, but also helps to predict or project future services/packages and events/transactions. This predictive force allows for optimizing customer/client management strategies, including service, cross-selling and retaining, and cost control, and for proactively managing the relationship with the customer/client. With this retaining engine optimizing technology, it is possible to perform unlimited “what-if” and goal-seeking optimization scenarios, thereby helping decision-makers to understand consequences of various business strategies and/or possibilities associated with outsourcing or completing the services/packages locally, in specific geographical locations, or “in-house”.

The retaining engine predictive optimization solutions enable clients and service providers to achieve maximum value from each individual customer and/or service provider or combination of service providers. The retaining engine decision technologies help to predict, test, track and optimize strategic and tactical goals based on a complete, integrated view of revenue, risk and costs. Precise, robust decision-making is the result of a framework that leverages multiple data sources and integrates statistics, neural networks and optimization technology. Service providers are able to segment their customer/client base in an intelligent way, run simulated marketing campaigns, and predict results before going into the field.

The disclosed retaining engine method and system yields improved results for several reasons. First, the retaining engine method/system has the ability to fully capture and measure the causal relationships and sensitivities between decision variables and subsequent customer/client behaviors. Decision variables are those variables that management can proactively control and change. Second, the retaining engine method/system optimizes and solves for long-term economic value, accurately representing the fulfill effect of all decisions over an extended period of time. Third, the result of the retaining engine method/system is robust optimization, which enables managers to understand and determine the stability and reliability of any decision under changing scenarios and environmental conditions. Fourth, using the retaining engine method/system, clients are able to optimize various financial and economic metrics within specific business requirements or policy constraints, and apply decisions to both the customer/client and portfolio levels. And fifth, with the retaining engine method/system, users are able to deliberately interact with the modeling, forecasting, and optimization process to effectively incorporate managerial judgment, policy, and strategic assessment into the final retaining decision. The retaining engine method/system thus facilitates and encourages cross-functional collaboration and cooperation to integrate both empirical data and experiential insight. The final solution is based on a representation of past and future relationships and behaviors.

According to the present disclosure, preferred retaining engine methods/systems have two features that combine short-term predictive modeling with long-term forecasting. The retaining engine method/system models the short-term events in detail, but past a certain point, it does a coarser grain forecasting. Also, the robust optimization, which looks at different scenarios of services/packages and risk profiles, goes beyond standard simulation models. The retaining engine method/system integration will enable service providers to gain greater insight into the relationships within their databases, but also to gain these results in a fraction of the time it has traditionally taken to analyze their databases.

The disclosed retaining engine method/system is not limited to auctions and the like, but may be effectively deployed as a portal for all service providers to use in posting services/packages of services for widespread access over a distributed network, e.g., the Internet or the World Wide Web, with or without a base price. The disclosed method/system provides a quick and easy way to shop for and retain services made possible by a comprehensive inventory of available services by service provider's that match consumer retaining preferences. Service providers are able to conveniently post their services in one general location, and have the ability to offer last minute specials in a manner that will permit the word to get out to companies and individuals. Service providers that are locally-based, with no global distribution channel, are provided a broad platform upon which to market and promote their services and capabilities.

Moreover, the disclosed method/system addresses several challenges confronting consumers as they set about researching, planning and purchasing service needs. For example, the disclosed retaining engine system resolves consumers' difficulties in finding a one-stop retaining resource for comprehensive and unbiased professional services and service research/planning (whether online or offline), including items such as comparative retaining reports for services and consumer reviews. Consumers are also provided with a destination on the Internet for comprehensive service provider or administrative support retaining, that is available when consumers have the opportunity to plan and shop for service provider's, often at times when service providers, temporary agencies and workforce centers are closed (i.e., after work and on weekends).

Of note, traditional temporary agencies and professional services do not proactively and routinely alert consumers to special deals. Online agencies are simply extensions of traditional agencies, generally lacking in-depth service provider and administrative support information and/or a sense of community. The method/system of the present disclosure overcome these shortcomings, offering consumers ready access to the capabilities and benefits of a wide range of service providers. Consumers are thus allowed to research and retain services in an interactive, fun environment at times that are convenient for them (available 24 hours a day, 7 days a week, 365 days a year). Utilizing functionalities such as a preferred “Find Services” search tool, consumers are able to search by title, price range, category, service location, and to sort by various criteria, view results and offer/access feedback on service providers via a rating system.

According to another aspect of the present disclosure, there is provided a computer-based system that includes a computer readable medium having computer readable code recorded thereon for negotiating the purchase or retaining of services and/or packages of services by customers utilizing a mechanism for receiving customer input data relating to particular services or packages of services desired to be purchased, a mechanism for processing the customer input data according to generate merchant responses to the customer input data, and a mechanism for agreeing to sell the services and/or packages of services to a customer at a particular price as a result of processing of customer replies to merchant responses. The responses are advantageously broken down into geographical locations/regions.

In preferred auction-based embodiments of the present disclosure, different locations/links are provided at which the consumer can place bids and/or can include competitive bidding for packages of different types of services. Users may consecutively enter prices they are willing to pay for specific services or packages of services, until a set deadline, thus bidding up the price. The service is then sold to the customer with the highest bid. This method may also advantageously encompass bids for individuals (e.g., guest speakers for seminars, etc.) on requested dates and times. Video clips may be utilized to showcase the capabilities of individuals over the Internet.

The retaining engine method/system according to the present disclosure may advantageously receive and store additional information for customer viewing. Such additional information may be collected/harvested using various computer systems, so that the retaining engine system can respond to requests/orders from users. The retaining engine system typically stores the received additional information in association with an identifier of the requesting customer, and provides the identifier to the retaining engine/client system When requested by the retaining engine/client system the retaining engine system provides information describing the service(s) or packages of services to the requesting client system When the retaining engine system receives a request from a client system, the retaining engine system combines the additional information stored in association with the identifier included in the request to effect the retaining of the service(s) or packages of services.

The present disclosure further provides a method/system for single-action retaining of services or packages of services in a retaining engine client/server environment. The single-action retaining system reduces the number of purchaser interactions needed to place a retainer/order and reduces the amount of sensitive information that is transmitted between a client system and a retaining engine/server system In one embodiment, the retaining engine system assigns a unique client identifier to each retaining engine/client system The retaining engine system also stores purchaser-specific information for various potential purchasers/retainers. The purchaser-specific order information may have been collected from a previous order/retainer placed by the purchaser. The retaining engine system maps each client identifier to a purchaser that may use that retaining engine/client system to place an order or retain services from a service provider. The retaining engine system may map the client identifiers to the purchaser who last placed an order using that retaining engine/client system When a purchaser wants to place an order to retain services, the purchaser uses a retaining engine/client system to send the request for information describing the service(s) or package of services to be retained/ordered along with its retaining engine/client identifier. The retaining engine system determines whether the retaining engine/client identifier for that retaining engine/client system is mapped to a purchaser. If so mapped, the retaining engine system determines whether single-action retaining is enabled for that purchaser at that retaining engine/client system. If enabled, the retaining engine system sends the requested information (e.g., via a Web page) to the retaining engine/client computer system along with an indication of the single action to be performed to place the order or retain the service(s)/package of services.

When single-action retaining is enabled, the purchaser need only perform a single action to retain desired service(s), e.g., click a mouse button. When the purchaser performs that single action, the retaining engine/client system notifies the retaining engine system The retaining engine system then completes the order by adding the purchaser-specific order information for the purchaser that is mapped to that retaining engine/client identifier to the service(s) (e.g., geographical location, service or package of services identifier, and quantity). Thus, once the description of a service or package of services is displayed, the purchaser need only take a single action to place the retainer/order and retain that service or package of services. Also, since the retaining engine/client identifier identifies purchaser-specific retaining/order information already stored at the retaining engine system, there is no need for such sensitive information to be retransmitted via the Internet or other communications medium.

According to preferred embodiments of the present disclosure, the disclosed Web-based retaining engine method/system is easy to use and does not require a purchase of software or payment of a connection fee in order to bid on services. Retaining engine solutions also offer buyers “total cost functionality.” This technology enables buyers to make purchase decisions based not only on price, but also on multiple criteria such as quality, delivery time and referral information. The disclosed method/system also offers the ability to eliminate the waiting process and bring the customer to a service provider in a more direct process, customer service and local geographical location. Buyers are now able to compare competing bids online, in real time, and to select a service provider based on a nix of priorities that together determine their total cost.

Thus, the method/system of the present disclosure effectively hangs customer retainer(s)/money on a “clothesline” for service providers to see. Attached to the retainer(s)/money is a note describing what the service provider must agree to do in order to take the retainer/money down off the clothesline. The disclosed method/system eliminates significant uncertainty and/or wastefulness generally associated with a service provider's efforts to identify service opportunities and consummate transactions associated therewith. Each participating service provider knows that if the conditions set forth by the customer can be met at the offered price, the service provider can immediately perform the service(s) and/or package of services and/or close the sale for prompt payment. The disclosed method/system reduces hassles and negotiations, providing a ready outlet for excess service capacity.

The method/system of the present disclosure also allows customers to reach a large number of potentially remotely-located service providers that would otherwise be beyond the customer's reach and/or knowledge. Through this expanded universe of service providers, customers are better able to locate service providers that can offer the exact service(s) and/or package of services desired by the customer at favorable price points.

In short, the method/system of the present disclosure provides a robust, scalable system for matching customers' requirements with service providers capable of satisfying those requirements. The disclosed method/system provides a potentially global bilateral, customer-driven system for creating binding contractual arrangements in which various methods of communication, commerce and security for the customer and the service provider may be achieved. The power of a central retaining engine controller to field binding offers from customers, communicate those offers globally in a format that can be efficiently accessed and analyzed by potential service providers, effectuate performance of resulting contractual relationships, resolve disputes arising from those contractual relationships, and/or maintain billing and retaining methods, collection, authentication, and anonymity, makes the various embodiments of the present disclosure a significant improvement over conventional requisitioning systems.

The method of the present disclosure finds specific utility and applicability for the retention of construction and architectural services, e.g., for the auctioning of architectural and construction services, construction materials, construction supplies and associated shipping methods. Thus, it is contemplated according to the present disclosure that a computer-implemented method/system may be provided for negotiating/performing continuous auctions over a computer network system directed to architectural and construction services (ACS), construction supplies and materials, and/or shipping methods (i.e., trucking, freight or shipping companies). Multiple potential buyers may compete for retaining and purchasing of ACS. It is further contemplated that referring users may utilize a “Business Service Referral Engine” (BSRFE) to refer ACS opportunities to other businesses, colleagues, family and friends.

A method/system is provided according to the present disclosure wherein information presentation and management is handled in an online retaining and or purchasing environment. According to one aspect of the present disclosure, person-to-person or business-to-consumer commerce over the Internet is facilitated by providing prospective buyers the ability to quickly preview ACS availability. Similarly, immediate viewing of construction materials and/or supplies available for purchase may be conveniently viewed. In both cases, availability is preferably broken down into geographical locations. Descriptions of the ACS and/or supplies and materials are optimally available from a plurality of ACS or material and supply companies or sites based upon user-supplied information.

The user-supplied information generally includes descriptions of the ACS, materials and supplies (or packages of ACS and/or materials and supplies), availability and geographic locations from which the foregoing can be retained and/or purchased. Shipping options are also generally included in the user-supplied information. Descriptions and/or videotapes may be created corresponding to the particular category and may be aggregated onto a Web page for presentation at a remote site. A user may submit a query to preview a particular category and/or packages containing ACS/materials/supplies or a combination of for sale. After receiving the query, descriptions and or videos corresponding to the category or packages that satisfy the user query are displayed.

Computer-implemented methods/systems according to the present disclosure generally allow consumers to search by ACS and/or product(s) and/or geographic location for the ACS of interest, and to specify desired shipping methods. The geographic specificity of the disclosed method/system allows consumers to locate local and/or specific ACS service providers and/or shipping service providers (SSPs). In addition, consumers are able to competitively bid for all types of ACS and/or related products and/or packages of services. Indeed, consumers can effectively pursue “package deals” that could include, for example, custom blue prints and a log home kit to be built in the United States, with free shipping services.

The disclosed method/system may provide targeted administrative support directed to construction and architectural services, e.g., broken into category sections such as new construction, blue prints, custom blue prints, pre fabricated materials, commercial and/or residential services. The disclosed method/system is particularly effective for accumulating a collective bid for various type(s) of architectural and/or construction services to be performed by a service provider, as well as associated shipping methods and/or shipping service providers.

The method of the present disclosure also finds specific utility and applicability for the retention of agricultural and farm-related services. According to preferred embodiments directed to the agricultural/farm sector, a computer-implemented method/system for negotiating/performing continuous auctions over a computer network system is advantageously provided. The auction generally includes conventional agricultural products/services, including services provided by agricultural producers (AP) with respect to livestock, grain(s) and the like. Shipping methods (i.e. trucking, freight or shipping companies) are generally included in the auction process, such that multiple clients/buyers are provided with purchasing ability with respect to livestock, grains, and the like, and their shipping methods. An auction-based method for selling and purchasing livestock, grains and other agricultural/farm products and services, together with associated shipping methods, via an auction format with instant purchasing capabilities generates customer input data. The disclosed method/system further contemplates a method/system for referring users (buyers and/or APs) via a “Business Service Referral Engine” (BSRFE) to other businesses, colleagues, family and friends.

The disclosed method/system may advantageously facilitate information presentation and management in an online purchasing environment. According to one preferred aspect, person-to-person or business-to-consumer commerce over the Internet is facilitated by providing prospective buyers the ability to quickly preview livestock and grain availability that can be purchased. Descriptions of livestock and grains, or packages of livestock/grains, may be provided to interested purchasers via videotapes and/or static HTML pages describing the livestock and grains. Such descriptive materials may be obtained from a plurality of APs or agricultural businesses based upon user-supplied information.

The user-supplied information includes descriptions of livestock and grains or packages of livestock and grains, as well as availability and locations from which livestock and grains may be shipped. Available shipping methods are also described for consideration and potential purchase by interested parties. Descriptions and/or videotapes are created corresponding to the particular category and are advantageously aggregated onto a Web page for presentation at a remote site. According to another aspect of the present disclosure, a user may submit a query to preview a particular category and/or packages of livestock/grains for prospective purchase. After receiving the query, descriptions and/or videotapes corresponding to the category or packages that satisfy the user query are displayed.

In a further preferred embodiment of the present disclosure, a method/system for conducting an on-line retaining session is disclosed, the on-line retaining session permitting, inter alia., the accumulation of a collective retainer consisting of incremental retainer amounts for use in acquiring a service or package of services from one or more service providers. The disclosed method/system further provides for conducting an on-line retaining auction that permits individual registered users to pool incremental retainer amounts (IRAs) during a retaining session. The retaining session is advantageously conducted over a computer network, e.g., the Internet or the World Wide Web, that includes a retaining engine, a number of remote computers, and communication lines connecting the remote computers to the retaining engine. According to a preferred embodiment of the disclosed method/system, at least one retaining group is registered in or by the retaining engine. Although the disclosed method/system is well suited to be conducted electronically, e.g., over the Internet, the disclosed method/system finds application beyond the electronic realm lending itself to advantageous use through other modes of communication, e.g., via facsimile, telephone, in-person, etc.

The retaining group is typically a franchise, association, business, large corporation or group of individuals formed or united for the purpose of retaining services and/or packages of services from service providers by placing together or contributing incremental retainer amounts (IRAs) for the purpose of retaining services or packages of services. Other forms of retaining groups are contemplated, however, e.g., ad hoc groups of charities, small businesses, incubators, universities and the like. A retaining group generally has a total retainer amount for use in acquiring service(s) and/or package(s) of services, which may be tracked by the retaining engine or by other means, e.g., by the participants in the retaining group.

Incremental retainer amounts may be entered from remote computers by one or more retaining group participants, and are typically received in the retaining engine. Each incremental retainer amount generally includes a retainer amount and a retainer designation. The retaining engine receives incremental retainer amounts entered from the remote computers by members of the retaining group and, based on the retainer designation, debits the appropriate IRA by the contributed amount. Each IRA thus includes individual IRA amounts that are contributed to the total retainer so as to accumulate the collective retainer for use in retaining service(s) or package(s) of services.

In a preferred embodiment of the present disclosure, retaining group(s) compete in auctions processed by a retaining engine system. In one embodiment, the retaining group having the largest total retainer committed to the purchase of an auctioned service or package of services at the end of a retaining session “wins” the auction and retains the service/package of services being auctioned. The total retainer is preferably displayed to the registered users on the remote computers, and updated in real-time after each IRA is added to the total retainer.

In a particularly advantageous embodiment, the method/system also includes the step of creating a registered user account for each registered user in an account creation computer networked to the retaining engine. Each registered user account typically includes a registered user name, a registered user identification number, and a financial account number, such as the registered user's credit card, checking account, or savings account number or escrowed retainer account number. In this preferred embodiment, each IRA received in the retaining engine generally includes the name and identification number of the person contributing the IRA. At the close of a retaining auction session, if the retaining group accumulates a total retainer sufficient to retain the service(s) and/or package of services, each individual IRA contributed to the total IRA is matched by registered user identification number to a corresponding registered user account. The corresponding registered user account is then charged the IRA amount contributed in connection with the retaining auction session, facilitating collection of the total retainer from the group.

The method/system may also include the step of registering a number of retaining groups in the retaining engine. The retaining groups may each constitute an association, business, franchise, large corporation, or group of individuals formed purely for the purpose of retaining together in order to distribute service(s) and/or packages of services among themselves, e.g., by lottery. At any given point in time, each retaining group has a total retainer available for use in purchasing service(s) and/or package(s) of services being auctioned. After starting a retaining session, IRAs or retainers entered from the remote computers continue to be received by the retaining engine, thereby incrementing up the amount of individual IRAs. The total retainer is preferably displayed to the registered users on the remote computers and updated in real-time after each IRAs is added to the total retainer.

Of note, the disclosed method/system for conducting an on-line retaining session need not be used exclusively for accumulating a collective retainer, i.e., an auction-based retaining session. Indeed, the disclosed method/system may be effectively used to accumulate a collective retainer for use in acquiring any type of service and/or package of services from one or more service providers according to any purchasing regimen. In a preferred embodiment of the present disclosure, a retaining auction may be used to auction service(s) and/or package(s) of services to a large entity/corporation/government agency or the like.

However, retaining auctions of the type disclosed herein are also effective for many other applications, such as the promotion of charitable causes and services. For example, charities often hold find raising auctions in which they sell valuable items that have been donated to the charity. The disclosed retaining auction method allows services and/or packages of services to be retained by affiliated groups of contributors, and generally increases the amount of funds a charity may raise in these auctions. The increase in charitable revenues may result from increased numbers of participants that is achieved by allowing easy, on-line access to the retaining auction. A further reason that charitable reasons may increase relates to allowing ordinary individuals, in addition to wealthy individuals, to contribute to the total retainer, expanding the pool of available finds,

In an alternative embodiment having particular applicability to charitable events, competitive retaining groups may be formed as described herein, each retaining group representing a different charitable cause. Each IRA or retainer contributed to a retaining group helps the respective charity, but only the winning group is awarded the service(s) and/or package(s) of services being auctioned and retained. The winning group may then stage a lottery to determine which of the contributing registered user(s) is permitted to keep or distribute the service(s) and/or package(s) of services acquired by the retaining group.

Further, as noted above, the disclosed on-line retaining auction method described herein need not be conducted over the Internet, e.g., using a World Wide Web server. Rather, the disclosed method is equally effective when deployed on any computer network that allows the transmission of data between registered users at remote locations, and that includes a retaining processor or central processor that is programmed to collect, track and apply IRAs. Similarly, the networking of the computer systems involved in the disclosed auction method may take many forms, e.g., Ethernet connections, dedicated communication lines (T1, T3,etc.), etc.

The steps of registering retaining groups and creating registered user accounts has been described as generally taking place prior to commencing a retaining session. However, this order of steps is merely illustrative. Indeed, retaining group(s) may be advantageously registered in the retaining engine after the commencement of a retaining session. For example, registered users wishing to participate in a retaining session, but not wishing to participate with any of the current retaining groups, may form o a new retaining group during the retaining session. In this case, the IRA and/or retainer entry form is updated during the retaining session with the name(s) of new retaining group(s). Similarly, registered users can create registered user accounts before or during a retaining session to contribute to the total retainer of a retaining group.

In a further embodiment of the present disclosure, a method/system that includes an automatic retaining method (ARM) utilizing an automatic retaining management system (ARMS) is provided. The disclosed automatic retaining method/system make it unnecessary for registered users, bidders and/or retaining groups to stay until the conclusion of a retaining auction. In addition, the disclosed method/system facilitates users, bidders and retaining groups in retaining services by breaking such services down into geographical locations on an open network on which it is difficult to assure reliable on-line and real time performance. Services according to the disclosed method/system may be retained directly or through retaining auctions. To facilitate ARM, auction retaining information is generally collected, including a desired retainer, location of the service provider, if applicable, date services are to be received, and the like.

To access the system, service providers (“SP”) and buyers (“B”) will need to initially register with the system. The registration will ask them to enter certain information about themselves. The SP will be asked to provide information on (but not necessarily limited to): services they perform, price range for services, geographic location, industries they may specialize in, work history experience, rating from a scale from 1-10 of their skills in a variety of skill sets to help determine strengths and weaknesses, and contact information. Buyers will be asked to provide information on (but not necessarily limited to): services required, time frame in which project needs to be finished, rating from a scale from 1-10 of the skills that are important to them, industry their business is in or related to, contact information, and geographic location.

The preceding data, along with other data, will be held in relational databases that will be filtered against one another to find the best match of SP with B. This filtering process requires no involvement of the SP or B, rather, the filtering process is automatically generated/accomplished by the databases and filtering systems. After information has been gathered and stored in the database, and transactions have been made, the transaction histories of the buyers and sellers will also be filtered into the ARMS system to help identify purchasing and selling patterns. SP and B will be notified of these patterns, giving the SP and B the option to automatically have generated matches within the system to fulfill their needs. B can also specify triggers within the system to automatically request specified services at a specified time for a specified price. SP will have the opportunity to set acceptance points to automatically accept request offers based on criteria that the SP has preset.

Thus, the automatic retaining and/or automatic retaining auction method generally operates such that registered users and/or retaining groups located in remote places participate in retaining by sending automatic retaining and/or automatic retaining auction information to an automatic retaining auctioneer. The automatic retaining and/or automatic retaining auction information is typically transmitted to the automatic retaining auctioneer via an open communication network, e.g., the Internet or the World Wide Web. Upon receipt of the automatic retaining and/or automatic retaining auction information by the auctioneer, the automatic retaining auction may be effectively and automatically conducted on the basis of such information.

On user terminals, information about the retaining auction is generally received from a retaining method/system. This information about the retaining auction may be procured spontaneously by registered users and/or may be forwarded to users according to the automatic retaining management system (ARMS) for receipt in due course by users, e.g., via e-mail. For a selected retaining auction community, the number of service(s) and/or package(s) of services to be retained, a desired retainer, and the highest possible retainer to be bid for the desired retaining of services are specified on the screen by the user. Such auction retaining information is advantageously transmitted to the automatic retaining management system (ARMS). In addition, parameters relevant to operation of the retaining auction, e.g., whether participation in the retaining auction should be conducted after an initial successful retainer is achieved, are preferably defined by auction participants and/or the ARMS.

At the automatic retaining auction start time, e.g., daily at 9 a.m., a retaining auction is started. At the automatic retaining auction, a retainer is first set. As for this retainer, an initial base retainer for starting the automatic retaining auction may be input, but is not required. Subsequently, the stored automatic retaining auction information is searched by the ARM for a desired retainer coinciding with the set base retainer. If there are automatic retaining auction matters, the transaction(s) are settled. Otherwise, a retainer is reset.

With reference to the process for resetting a retainer, the retainer is lowered in cases where there are no retaining auction issues (i.e., in the case of a noncompetitive state). In cases where the amount of the automatic retaining auction community does not satisfy automatic retaining auction matters (e.g., in the case where [the amount of services and or packages of services can be retained]<[retaining auction issues], i.e., in the case of a competitive state), the automatic retaining auction retainer is raised. Such determination is made by ascertaining whether the desired retainer coincides with an automatic retaining auction matter. In the case of a competitive state, however, it is determined by comparing “the set base retaining auction retainer” with “the desired retainer” relative to “the highest possible retainer in competition.” Until all automatic retaining auction matters and/or services are retained or a fixed base retainer is reached, such processing is repeated. The processing associated with the automatic retaining method and system is typically implemented using appropriately programmed computer systems. Such programs may be stored on an appropriate storage medium, e.g., a floppy disk, an optical disk, a hard drive and/or network attached storage, and can be distributed via a network.

Owing to the measures heretofore described, it is possible to prevent a third party who does not know the registered user's ID and/or password from participating in the retaining transaction. Furthermore, it is possible to prevent a person having no encryption key from conducting wiretapping for data concerning the automatic retaining auction and falsifying data concerning the automatic retaining and/or automatic retaining auction.

In a further embodiment of the present disclosure, an automatic conditional retaining offer (ACRO) is provided to a retaining engine by a registered user and/or a retaining group and is evaluated against a number of automatic ACRO rules defined by a plurality of service providers to determine whether such service providers are willing to accept the ACRO. An automatic ACRO rule is a set of restrictions defined by a given service provider to define a combination of restrictions pursuant to which the service provider is willing to accept an automatic predefined minimum price. The automatic ACRO rules are utilized by an automatic ACRO management system to render a decision to accept, reject or counter an automatic ACRO on behalf of a particular service provider. The automatic ACRO rules may be generated by the ARM and/or within the automatic retaining management system (ARMS) of the respective service providers by evaluating current scheduling availability, inventory, pricing and revenue information, as well as historical patterns, to forecast future demand.

The automatic ACRO management system preferably includes an automatic ACRO management central automatic retaining engine/server and one or more automatic retaining engine/secured servers. Each automatic retaining engine/secured server may be associated with one or more service providers and each automatic retaining engine/server stores, among other things, the automatic ACRO rules defined by any associated service provider(s). Each secured automatic retaining engine/server may be remotely located from the automatic ACRO management central automatic retaining engine/server, or may be integrated with the automatic ACRO management central automatic retaining engine/server.

In an exemplary embodiment of the present disclosure, the secured automatic retaining engine/server associated with one or more service providers may be physically located at a processing facility secured by the particular service provider. The automatic ACRO rules may be securely stored by an automatic retaining engine/server, e.g., to prevent one service provider from accessing, obtaining or altering the automatic ACRO rules of another service provider.

Once the terms of the automatic ACRO have been received by the automatic ACRO management system, the automatic ACRO management central automatic retaining engine/server determines whether one or more service providers will accept the received automatic ACRO. Thereafter, the customer is generally notified of the response of the service providers to the automatic ACRO. If a service provider automatically accepts the automatic ACRO, or if the customer preferences automatically accept an automatic counteroffer from a service provider, service(s) and/or package(s) of services are retained by the automatic ACRO management system with the appropriate restrictions.

The automatic ACRO management system preferably allows a number of service providers to conditionally accept each automatic ACRO. In this manner, the automatic ACRO management system can ensure that at least one of the accepting service providers will have the available service in the condition specified by the buyer. Preferably, each of the accepting service provider(s) is prioritized into a hierarchy based on predetermined criteria, Thus, the automatic authenticator generally evaluates the service(s) and/or packages of services received from each service provider in the hierarchy, in the appropriate order, until the service(s) are in the condition specified by the buyer. For example, service providers may be automatically assigned a priority in the hierarchy based on the order in which their automatic acceptances are received by the automatic ACRO management system. In addition, the priority may be based on the performance of each accepting service provider for previous tasks. Alternatively, priority may be determined based on the geographical proximity of each accepting service provider to the buyer.

According to a further aspect of the disclosed method/system, the automatic ACRO management system prevents customers from submitting multiple automatic ACROs containing a progressively increasing price in order to identify the service provider's defined minimum retainer/price for given service(s) and/or package(s) of services. For example, if an automatic ACRO will be binding upon the customer if accepted by any service provider, the customer is inherently discouraged from “pinging” the automatic ACRO management system to identify the service provider 's underlying price flexibility. In addition, the automatic ACRO management system can limit the number of automatic ACROs that a customer can submit within a predefined time period.

Customers may contact the automatic ACRO management system by telephone, facsimile, online access, e-mail, in-person contact and/or through an agent, to provide the automatic ACRO management system with the terms of their automatic ACRO. In one preferred embodiment, the customer may contact the automatic ACRO management system by means of a telephone, with the automatic ACRO management system collecting information from the customer related to the automatic ACRO using an interactive virtual personal assistant.

Once the terms of the automatic ACRO have been received by the automatic ACRO management system, the automatic ACRO management central automatic retaining engine/server will execute an automatic ACRO management process to compare the received automatic ACRO against the automatic ACRO rules of each service provider, to determine whether to accept, reject or counter the automatic ACRO. This procedure advantageously eliminates the need for customers to be notified of the automatic response of the service providers to an automatic ACRO. If a service provider automatically accepts the ACRO, or if the customer automatically accepts an automatic counteroffer from a service provider, service(s) and/or package(s) of services are then retained by the automatic ACRO management system with the appropriate restrictions.

The automatic ACRO management system may optionally access a central retaining system (CRS) or proprietary service provider retaining and scheduling system for each service provider, to perform itinerary queries that will identify particular services and/or packages of services that satisfy a given itinerary, and to make scheduling arrangements.

Although the above description contains much specificity, this specificity should not be construed as limiting the scope of the disclosed invention, but merely as illustrating presently preferred embodiments. Many other embodiments of the disclosed method/system are possible, without departing from the spirit or scope of the present disclosure. For example, the method/system of the present disclosure is effective for accumulating a collective bid for any type of services or packages of services performed by service providers. In addition, the disclosed method/system need not be conducted over the Internet using a World Wide Web server. Rather, the disclosed method/system is effective using any network that allows the transmission of data between bidders at remote locations and a central processor. Similarly, modems are not necessary to network the central computer or retaining engine, account creation computer, and remote computers. Many other methods of connection are possible, as is well known in the art of computer networking. Therefore, the scope of the claimed invention should be determined by the appended claims and their legal equivalents.

1. A computer-implemented method for creating a services marketplace, comprising:
a. providing a site accessible to service providers and purchasers of services;
b. storing descriptions of services that are available for purchase, said descriptions of services being supplied to said site by service providers;
c. receiving a request from a purchaser to acquire desired services;
d. automatically determining whether one or more stored descriptions of services correspond to said desired services; and
e. communicating to said purchaser one or more descriptions of services that correspond to said desired services.

2. A computer-implemented method for creating a services marketplace according to claim 1, wherein said site is a Web site hosted on and accessible by a network of computers.

3. A computer-implemented method for creating a services marketplace according to claim 2, wherein said network of computers is selected from a group consisting of the Internet and the World Wide Web.

4. A computer-implemented method for creating a services marketplace according to claim 1, wherein said service providers and said purchasers of services are required to register in order to gain access to one or more aspects of said site.

5. A computer-implemented method for creating a services marketplace according to claim 4, wherein registration is required before a service provider may supply a description of services to said site.

6. A computer-implemented method for creating a services marketplace according to claim 5, wherein registration is required before a purchaser of services may submit an request for desired services to said site.

7. A computer-implemented method for creating a services marketplace according to claim 1, further comprising:
a. providing a registration procedure for said service providers and said purchasers of services, said registration procedure requiring submission of registration information; and
b. storing said registration information submitted as part of said registration procedure.

8. A computer-implemented method for creating a services marketplace according to claim 7, wherein said registration information for said purchasers of services includes at least one payment mode for use in purchasing services.

9. A computer-implemented method for creating a services marketplace according to claim 8, wherein said at least one payment mode is selected from the group consisting of credit card information, debit card information, electronic cash information, billing, invoicing, and combinations thereof.

10. A computer-implemented method for creating a services marketplace according to claim 8, further comprising:
a. verifying said payment modes included with said registration information by said purchasers of services.

11. A computer-implemented method for creating a services marketplace according to claim 1, wherein said descriptions of services supplied to said site by said service providers include services information selected from the group consisting of: background information concerning said service providers, contact information for said service providers, pricing schedule for said service providers, at least one sample of work performed by said service providers, at least one link to additional information concerning said service providers, availability of said service providers to perform said services, one or more categories for classification of said services, and combinations thereof.

12. A computer-implemented method for creating a services marketplace according to claim 1, further comprising:
a. categorizing said descriptions of services supplied to said site by said service providers in one or more service categories; and
b. storing said description of services within said one or more service categories.

13. A computer-implemented method for creating a services marketplace according to claim 12, wherein said one or more categories are based on criteria selected from the group consisting of geographic location of said service provider, nature of services available for purchase from said service provider, availability of said service provider to perform said services, pricing schedule for said services, and combinations thereof.

14. A computer-implemented method for creating a services marketplace according to claim 1, wherein said description of services includes all material terms associated with performance thereof by said service provider.

15. A computer-implemented method for creating a services marketplace according to claim 14, wherein said material terms are selected from the group consisting of price, timeframe, payment schedule, and combinations thereof.

16. A computer-implemented method for creating a services marketplace according to claim 1, wherein additional information is communicated to said purchaser concerning service providers that have supplied descriptions of services that correspond to said desired services, said additional information being selected from the group consisting of one or more video files, one or more audio files, one or more HTML pages, one or more testimonial statements, one or more samples of completed work, and combinations thereof.

17. A computer-implemented method for creating a services marketplace according to claim 1, wherein said plurality of purchasers submit said desired services to said site using a Web browser.

18. A computer-implemented method for creating a services marketplace according to claim 17, wherein said purchasers communicate with said site using an electronic unit selected from the group consisting of a personal computer, a cellular phone, a PDA, a television, and combinations thereof.

19. A computer-implemented method for creating a services marketplace according to claim 1, wherein said request for desired services is submitted to said site using a communication mode selected from the group consisting of electronic transmissions, electronic mail, facsimile transmission, telephone, postal submission, common carrier submission, and combinations thereof.

20. A computer-implemented method for creating a services marketplace according to claim 1, wherein said request for desired services sets forth one or more material terms pursuant to which said purchaser will agree to purchase said desired services.

21. A computer-implemented method for creating a services marketplace according to claim 20, wherein said one or more material terms is selected from the group consisting of price, payment terns, completion timeframe, service quality, geographic constraints, a deadline for response to acquisition request, and combinations thereof.

22. A computer-implemented method for creating a services marketplace according to claim 20, further comprising:
a. automatically supplementing said one or more material terms set forth in said request for desired services with non-material terms required to establish a contractual relationship.

23. A computer-implemented method for creating a services marketplace according to claim 20, wherein said request for desired services defines a conditional retaining offer that automatically forms a binding contractual relationship with a service provider insofar as said service provider has submitted a description of services that corresponds to said conditional retaining offer.

24. A computer-implemented method for creating a services marketplace according to claim 23, wherein said conditional retaining offer includes an agreement to pay for said desired services insofar as said service provider has submitted a description of services that corresponds to said conditional retailing offer using an identified payment mode.

25. A computer-implemented method for creating a services marketplace according to claim 24, further comprising:
a. verifying said identified payment mode and creditworthiness of said purchaser; and

26. A computer-implemented method for creating a services marketplace according to claim 1, further comprising:
a. limiting an ability of said purchaser to submit multiple requests for desired services to said site.

27. A computer-implemented method for creating a services marketplace according to claim 26, wherein said limitation includes restricting said purchaser to a predetermined number of requests for desired services within a predetermined timeframe.

28. A computer-implemented method for creating a services marketplace according to claim 1, further comprising:
a. establishing a hierarchy of service providers that have submitted descriptions of services that correspond to said desired service based on predetermined criteria, and
b. communicating said hierarchy to said purchaser.

29. A computer-implemented method for creating a services marketplace according to claim 28, wherein said hierarchy is based on price.

30. A computer-implemented method for creating a services marketplace according to claim 28, wherein said hierarchy is based on non-price factors selected from the group consisting of service quality, service reputation, geographic location, timeframe and combinations thereof.

31. A computer-implemented method for creating a services marketplace according to claim 1, further comprising:
a. receiving an identification of an accepted description of services to be retained by said purchaser from among said one or more descriptions of services that correspond to said desired services, and
b. providing post-acceptance services to said purchaser and service provider.

32. A computer-implemented method for creating a services marketplace according to claim 31, wherein said post-acceptance services are selected from the group consisting of processing of payments, dispute resolution, escrow services, and combinations thereof.

33. A computer-implemented method for creating a services marketplace according to claim 32, further comprising:
a retaining a disinterested third party to provide said dispute resolution post-acceptance services to said purchaser and said service provider.

34. A computer-implemented method for creating a services marketplace according to claim 1, wherein said site is accessible over a computer network and further comprising:
a providing access to a virtual assistant at said site, said virtual assistant being computer-generated and utilizing holographic technology with respect to transmission and display thereof.

35. A computer-implemented method for creating a services marketplace according to claim 1, further comprising:
a. creating log files reflecting activities of said purchasers and service providers at said site; and
b. utilizing said log files to create statistical reports related to said activities.

36. A computer-implemented method for creating a services marketplace according to claim 35, further comprising:
a utilizing said log files for a purpose selected from the group consisting of data mining, personalized communications, e-mail communications, targeted advertising, rewards programs, marketing analysis, market research and combinations thereof.

37. A computer-implemented method for creating a services marketplace according to claim 1, further comprising:
a. establishing one or more packages of services available for purchase based on descriptions of services supplied to said site by one or more of said service providers; and
b. storing said one or more packages of services with said stored descriptions of services for use in automatically determining whether one or more stored descriptions of services correspond to said desired services.

38. A computer-implemented method for creating a services marketplace according to claim 37, further comprising:
a. communicating to said purchaser one or more stored packages of services that correspond to said desired services.

39. A computer-implemented method for creating a services marketplace according to claim 38, wherein said service providers allocate service responsibilities and revenues based on respective contributions to said one or more packages of services.

40. A computer-implemented method for creating a services marketplace according to claim 1, further comprising:
a. providing a search capability at said site, said search capability permitting said purchasers to search for services that are available for purchase based on stored descriptions of services.

41. A computer-implemented method for creating a services marketplace according to claim 40, wherein said search capability utilizes one or more key words to locate services that are available for purchase.

42. A computer-implemented method for creating a services marketplace according to claim 41, wherein said one or more key words are selected from the group consisting of service descriptors, service provider names, service categories, geographic locations, and combinations thereof.

43. A computer-implemented method for creating a services marketplace according to claim 1, further comprising:
a. receiving a communication from one or more of said purchasers establishing a retaining group, said retaining group being established to provide one or more unitary requests to acquire desired services;
b. registering said purchasers that define said retaining group; and
c. receiving information from one or more of said registered purchasers, said information including a level of financial participation in said retaining group.

44. A computer-implemented method for creating a services marketplace according to claim 43, wherein said retaining group includes registered purchasers that possess a commonality of interest in acquiring services.

45. A computer-implemented method for creating a services marketplace according to claim 1, wherein said service providers offer services that are selected from the group consisting of medical services, legal services, accounting services, financial services, building services, construction services, architectural services, health fitness services, agricultural services, farm services, nursing services, bookkeeping services, administrative services, graphic design services, photographic services, programming services, Web design and development services, and combinations thereof.

46. A computer-implemented method for creating a services marketplace according to claim 1, further comprising;
a. conducting a buyer-driven auction for services available for purchase from said service providers.

47. A computer-implemented method for creating a services marketplace according to claim 46, wherein said purchasers participate in said auction by communicating with said site across a computer network.

48. A computer-implemented method for creating a services marketplace according to claim 47, wherein participation in said auction by one or more of said purchasers is based on bid information supplied to said site at one or more points in time prior to completion of said auction.

49. A computer-implemented method for creating a services marketplace according to claim 48, wherein said bid information includes a maximum bid that is supplied at a point in time prior to said auction reaching a level corresponding to said maximum bid.

50. A computer-implemented method for creating a services marketplace according to claim 49, wherein said maximum bid is taken into consideration when said auction reaches a level corresponding to said maximum bid, regardless of whether said purchaser is then-participating in said auction.

51. A computer-implemented method for creating a services marketplace according to claim 1, further comprising:
a. securing one or more components of said description of services supplied to said site from inspection by third parties without required clearance.

52. A computer-implemented method for creating a services marketplace according to claim 1, wherein transmissions to and from said site are encrypted.

53. A computer-implemented method for creating a services marketplace, comprising:
a. providing a site accessible to service providers and purchasers of services,
b. storing a description of a project that a retaining purchaser desires to purchase, said project description being supplied to said site by said retaining purchaser;
c. displaying said project description for consideration by a plurality of service providers;
d. receiving a commitment from at least one of said plurality of service providers to perform said project pursuant to said project description; and
e. communicating said commitment to said retaining purchaser.

54. A computer-implemented method for creating a services marketplace according to claim 53, wherein said site is a Web site hosted on and accessible by a network of computers.

55. A computer-implemented method for creating a services marketplace according to claim 54, wherein said network of computers is selected from a group consisting of the Internet and the World Wide Web.

56. A computer-implemented method for creating a services marketplace according to claim 53, wherein said plurality of service providers and said retaining purchaser are required to register in order to gain access to one or more aspects of said site.

57. A computer-implemented method for creating a services marketplace according to claim 56, wherein registration is required before a retaining purchaser may supply a project description to said site.

58. A computer-implemented method for creating a services marketplace according to claim 57, wherein registration is required before a service provider may submit a commitment to perform pursuant to said project description.

59. A computer-implemented method for creating a services marketplace according to claim 53, further comprising:
a. providing a registration procedure for said service providers and said purchasers of services, said registration procedure requiring submission of registration information; and
b. storing said registration information submitted as part of said registration procedure.

60. A computer-implemented method for creating a services marketplace according to claim 53, wherein said project description includes at least one payment mode for use in paying for said project, said payment mode being selected from the group consisting of credit card information, debit card information, electronic cash information, billing, invoicing and combinations thereof.

61. A computer-implemented method for creating a services marketplace according to claim 60, further comprising:
a. verifying said payment modes included with said project.

62. A computer-implemented method for creating a services marketplace according to claim 53, wherein said project description supplied to said site by said retaining purchaser includes project information selected from the group consisting of background information concerning said purchaser, contact information for said purchaser, maximum price for completion of said project, required timeframe for project completion, one or more categories for classification of said project, geographic requirements, service-related inquiries, and combinations thereof.

63. A computer-implemented method for creating a services marketplace according to claim 53, further comprising:
a. categorizing said project description supplied to said site by said retaining purchaser in one or more project categories; and
b. storing said project description within said one or more project categories.

64. A computer-implemented method for creating a services marketplace according to claim 63, wherein said one or more categories are based on criteria selected from the group consisting of geographic location of said purchaser, nature of said project, timeline for project completion, maximum price for said project, and combinations thereof.

65. A computer-implemented method for creating a services marketplace according to claim 53, wherein said project description is transmitted for display by said service providers across a computer network.

66. A computer-implemented method for creating a services marketplace according to claim 65, wherein a bid is solicited from one or more of said service providers.

67. A computer-implemented method for creating a services marketplace according to claim 66, wherein said bid is solicited through communications with one or more of said service providers based on registration information supplied to said site by said plurality of service providers.

68. A computer-implemented method for creating a services marketplace according to claim 53, wherein said service providers display said project description using a Web browser.

69. A computer-implemented method for creating a services marketplace according to claim 68, wherein said service providers display said project description on an electronic unit selected from the group consisting of a personal computer, a cellular phone, a PDA, a television, and combinations thereof.

70. A computer-implemented method for creating a services marketplace according to claim 53, wherein said commitment is submitted to said site using a communication mode selected from the group consisting of electronic transmissions, electronic mail, facsimile transmission, telephone, postal submission, common carrier submission, and combinations thereof.

71. A computer-implemented method for creating a services marketplace according to claim 53, wherein said project description sets forth one or more material terms pursuant to which said retaining purchaser will agree to purchase services related to said project.

72. A computer-implemented method for creating a services marketplace according to claim 71, wherein said material terms are selected from the group consisting of price, payment terms, completion timeframe, service quality, geographic constraints, a deadline for response to project description, and combinations thereof.

73. A computer-implemented method for creating a services marketplace according to claim 71, further comprising:
a. automatically supplementing said one or more material terms set forth in said project description with non-material terms required to establish a contractual relationship.

74. A computer-implemented method for creating a services marketplace according to claim 71, wherein said project description defines a conditional retaining offer that may be accepted by said service providers to form a binding contractual relationship.

75. A computer-implemented method for creating a services marketplace according to claim 74, wherein said conditional retaining offer includes an agreement to pay for said services upon acceptance of said conditional retaining offer by one of said service providers using an identified payment mode.

76. A computer-implemented method for creating a services marketplace according to claim 75, further comprising:
a. verifying said identified payment mode and creditworthiness of said retaining purchaser.

77. A computer-implemented method for creating a services marketplace according to claim 53, further comprising:
a. limiting an ability of said retaining purchaser to submit multiple project descriptions for consideration by said service providers with respect to said project.

78. A computer-implemented method for creating a services marketplace according to claim 77, wherein said limitation includes restricting said retaining purchaser to a predetermined number of project description submissions with respect to said project within a predetermined timefrane.

79. A computer-implemented method for creating a services marketplace according to claim 53, wherein said commitment is selected from the group consisting of an outright acceptance of said project description, a counterproposal with respect to said project description, a request for clarification with respect to said project description, and a statement addressing aspects of said project description.

80. A computer-implemented method for creating a services marketplace according to claim 79, wherein said commitment is a counterproposal and further comprising:
a. receiving a retaining purchaser response to said counterproposal; and
b. communicating said retaining purchaser response to said service provider.

81. A computer-implemented method for creating a services marketplace according to claim 79, wherein said commitment is an outright acceptance and further comprising:
a. providing post-acceptance services to said retaining purchaser and said service provider.

82. A computer-implemented method for creating a services marketplace according to claim 81, wherein said post-acceptance services are selected from the group consisting of processing of payments, dispute resolution, escrow services, and combinations thereof.

83. A computer-implemented method for creating a services marketplace according to claim 82, further comprising:
a. retaining a disinterested third party to provide said dispute resolution post-acceptance services to said retaining purchaser and said service provider.

84. A computer-implemented method for creating a services marketplace according to claim 53, wherein said site is accessible over a computer network and further comprising:
a. providing access to a virtual assistant at said site, said virtual assistant being computer-generated and utilizing holographic technology with respect to transmission and display thereof.

85. A computer-implemented method for creating a services marketplace according to claim 53, further comprising:
a. creating log files reflecting activities of said purchasers and said service providers at said site; and
b. utilizing said log files to create statistical reports related to said activities.

86. A computer-implemented method for creating a services marketplace according to claim 85, further comprising:
a. utilizing said log files for a purpose selected from the group consisting of data mining, personalized communications, e-mail communications, targeted advertising, rewards programs, marketing analysis, market research and combinations thereof.

87. A computer-implemented method for creating a services marketplace according to claim 53, further comprising:
a. providing a search capability at said site, said search capability permitting said service providers to search stored project descriptions that are available for performance.

88. A computer-implemented method for creating a services marketplace according to claim 87, wherein said search capability utilizes one or more key words to locate project descriptions that are available for performance.

89. A computer-implemented method for creating a services marketplace according to claim 88, wherein said one or more key words are selected from the group consisting of project descriptors, purchaser names, product description categories, geographic locations, maximum price levels, and combinations thereof.

90. A computer-implemented method for creating a services marketplace according to claim 53, wherein said service providers offer services that are selected from the group consisting of medical services, legal services, accounting services, financial services, building services, construction services, architectural services, health fitness services, agricultural services, farm services, nursing services, bookkeeping services, administrative services, graphic design services, photographic services, programming services, Web design and development services, and combinations thereof.

91. A computer-implemented method for creating a services marketplace according to claim 53, further comprising:
a. conducting an auction for projects available for performance from retaining purchasers.

92. A computer-implemented method for creating a services marketplace according to claim 91, wherein said service providers participate in said auction by communicating with said site across a computer network.

93. A computer-implemented method for creating a services marketplace according to claim 92, wherein participation in said auction by said service providers is based on bid information supplied to said site at one or more points in time prior to completion of said auction.

94. A computer-implemented method for creating a services marketplace according to claim 93, wherein said bid information includes a maximum bid that is supplied at a point in time prior to said auction reaching a level corresponding to said maximum bid.

95. A computer-implemented method for creating a services marketplace according to claim 94, wherein said maximum bid is submitted when said auction reaches a level corresponding to said maximum bid, regardless of whether said service provider is then-participating in said auction.

96. A computer-implemented method for creating a services marketplace according to claim 53, further comprising:
a. securing one or more components of said project description supplied to said site from inspection by third parties without required clearance.

97. A computer-implemented method for creating a services marketplace according to claim 53, wherein transmissions to and from said site are encrypted.

98. A computer-implemented method for creating a services marketplace according to claim 53, wherein multiple commitments are received from said service providers to perform pursuant to said project description.

99. A computer-implemented method for creating a services marketplace according to claim 98, further comprising:
a. establishing a hierarchical listing of said multiple commitments; and
b. communicating said hierarchical listing of said multiple commitments to said retaining purchaser.

100. A computer-implemented method for creating a services marketplace according to claim 99, wherein said hierarchical listing is based on predetermined criteria selected from the group consisting of response time, prior commitments received from said plurality of service providers, prior performances by said plurality of service providers, and combinations thereof.

101. A computer-implemented method for creating a services marketplace according to claim 99, further comprising:
a. providing supplemental information to said retaining purchaser related to said service providers included in said hierarchical listing.

102. A computer-implemented method for creating a services marketplace according to claim 101, wherein said supplemental information is provided through links to Web-based information concerning said service providers included in said hierarchical listing.

103. A computer-implemented method for creating a services marketplace according to claim 53, further comprising:
a. providing computer-based interactivity between said service providers and said purchaser with respect to said project.

104. A computer-implemented method for creating a services marketplace according to claim 103, wherein said computer-based interactivity is selected from the group consisting of chat and instant messaging.
